(19) United States
(12) Patent Application Publication
(10) Pub. No.: US 2025/0093214 A1
(43) Pub. Date: Mar. 20, 2025

(54) USE OF ENCAPSULATED POLAR PROTIC CHEMISTRIES FOR RFID TEMPERATURE MONITORING

(71) Applicant: Temptime Corporation, Morris Plains, NJ (US)

(72) Inventors: Brian S. HUFFMAN, Belle Mead, NJ (US); Deniz BOYU, Dover, NJ (US)

(73) Assignee: Temptime Corporation, Morris Plains, NJ (US)

(21) Appl. No.: 18/369,506

(22) Filed: Sep. 18, 2023

(51) Int. Cl. G01K 11/06; G01K 1/024

(52) U.S. Cl. CPC G01K 11/06; G01K 1/024

(57) ABSTRACT

The use of encapsulated polar protic chemistries for RFID temperature monitoring are disclosed herein. An example activatable environmental indicator includes a substrate, an indicator material, and a plurality of microcapsules. The indicator material comprises a polar protic organic material. The plurality of microcapsules is on or embedded in the substrate and are configured to respond to at least one of an activation temperature and an activation pressure which allow the polar protic material to be released from the microcapsules. After being released from the microcapsules, the indicator material, responsive to exposure to a temperature above the predetermined melting point, is configured to transition to the liquid state and to travel along or through the substrate to create cause a change in an electrical property of the electrical component, the change in electrical property indicating that the activatable environmental indicator has been exposed to the temperature above the predetermined melting point.

### BACKGROUND

Perishable products including pharmaceuticals, food products, biologics, which may become unfit or unsafe for use after a certain length of time, or after exposure to various environmental conditions such as high temperature, radiation, ultraviolet (UV) or other light exposure, oxygen exposure, freezing, thawing, or simply the passage of time, or the combination of multiple conditions, such as cumulative excess heat exposure over time. It is desirable to include environmental exposure indicators on such perishable products, or on or in their containers or packaging, in order to detect when products are either unfit for use, or approaching the end of their useful life.

Many indicators are irreversible, or at least have strong hysteresis effects, so that they provide a reliable view of historical exposure to environmental conditions. For example, an indicator might change color when temperature exceeded a threshold and maintain that changed color even after the temperature returned below the threshold, so that someone inspecting the indicator would be informed that the product had been exposed to the excessive temperature. Alternatively, rather than a color changing chemistry, a chemical indicator material may be used, where the chemical indicator material responds to a change in condition in a manner that causes a change in an electrical property of the indicator material itself, or of another component of the device that is affected by the change in condition of the chemical indicator material. For example the chemical material might liquefy resulting in a change of electrical property, e.g., closing or opening a circuit, or reducing or increasing a resistance of the indicator material, or a causing a change in resistance or capacitance of an electrical component which includes the chemical indicator material as an element or which has a component that affected by it. For example, the material might liquefy, and then flow into a porous dielectric of a capacitor, thereby eliminating air gaps changing dielectric constant the dielectric and, as a result, the capacitance of the capacitor. This change in electric component property may then change the operation of an electrical circuit or device like an RFID tag, e.g., by turning it off or on or changing its operating frequency. Because RFID tags are ubiquitous, adding these environmental exposure indicator materials to them may allow environmental exposure to products in a supply chain to be monitored using a conventional, or slightly modified, RFID tag reader. Examples of such RFID tag-based environmental exposure indicators are found in Temptime Corporation/Zebra Technologies U.S. patent application Ser. No. 17/867,031 filed Jul. 18, 2022 and U.S. Pat. No. 10,095,972 filed Feb. 18, 2017.

Particularly for sensitive indicators, or indicator materials intended to have a long shelf life, it is desirable that the indicators remain inactive until they are incorporated in a printed label, and/or actually paired with a product that is entering the supply chain or moving into a different phase of the supply chain. This may avoid the need to carefully control the environment in which the indicator is stored prior to activation. In a conventional indicator that does not have an activation, the indicator may need to be stored in highly controlled conditions prior to deployment with a product. For example, a cumulative heat indicator might be stored prior to being paired with a product in a deep freeze; a threshold indicator configured to detect heating above refrigeration temperatures would need to be stored in a refrigerated environment prior to deployment; a sensitive humidity detector would need to be stored in controlled dry conditions. Accordingly, indicators which require an active process to “activate” the indicator and cause it to begin to operate are desirable for many applications. Prior “activatable” environmental indicators have included, e.g., two chemical components, whose reaction controls the indicator process, which are in provided separately and then are brought into contact using physical connection. Examples include reactants in separate reservoirs in a clamshell structure that is folded together to bring the reactants into potential contact with other, and to react after a predetermined environmental exposure occurs. Another example is providing reactants in two films that are affixed to each other, e.g., with an adhesive, when the indicator is activated, such as the indicators described in U.S. Pat. No. 6,544,925 to Prusik et al. Other examples include indicators with a removable film barrier that can be withdrawn, e.g., by manually pulling it out, from between the two chemical components.

Thermal printers, which use high temperature print heads to change the color of special printable media, are ubiquitous in the supply chains of many industries. The present disclosure describes activatable indicators that are optimized for use in the existing thermal printing ecosystem and that have changing electrical properties in response to predetermined environmental stimuli.

### SUMMARY

Disclosed herein are encapsulated polar protic chemistries for use in environmental indicators that indicate exposure to an environmental condition using an electrical property change, for example temperature monitors combined with RFID tags, where the environmental exposure indication can be detected by interrogating the RFID tag.

In an embodiment, the present disclosure includes an activatable environmental indicator comprising a substrate, an indicator material, and a plurality of microcapsules. The indicator material has a predetermined melting point. The indicator material further comprises a polar protic organic material. The plurality of microcapsules is on or embedded in the substrate. The microcapsules encapsulate the indicator material in a solid state and retain the indicator material when the indicator material transitions to a liquid state. The microcapsules are configured to respond to at least one of an application of heat to reach an activation temperature or an application of an activation pressure which allow the polar protic material to be released from the microcapsules. After being released from the microcapsules, the indicator material, responsive to exposure to a temperature above the predetermined melting point, is configured to transition to the liquid state and to travel along or through the substrate to create cause a change in an electrical property of the electrical component, the change in electrical property indicating that the indicator material has been exposed to the temperature above the predetermined melting point.

In another aspect of the present disclosure, which may be used in combination with any other aspect or combination of aspects listed herein, the indicator material further comprises a polymer having crystallinity.

In another aspect of the present disclosure, which may be used in combination with any other aspect or combination of aspects listed herein, the polar protic organic material is chosen from a list consisting of polyethylene glycol, acetic acid, methanol, ethanol, propanol, butanol, pentadecanol, hexanol, decanol, undecanol, dodecanol, and tridecanol.

In another aspect of the present disclosure, which may be used in combination with any other aspect or combination of aspects listed herein, the electrical component is a capacitor and the change of electric property is a change in capacitance of the capacitor.

In another aspect of the present disclosure, which may be used in combination with any other aspect or combination of aspects listed herein, the electrical component is a capacitance structure including multiple capacitors and the change of electrical property is a change of capacitance of the capacitance structure.

In another aspect of the present disclosure, which may be used in combination with any other aspect or combination of aspects listed herein, the electrical component is a resistor and the change of electric property is a change in resistance.

In another aspect of the present disclosure, which may be used in combination with any other aspect or combination of aspects listed herein, the electrical component is part of an RFID tag and the change in electrical property results in a change in information transmitted by the RFID tag, the RFID ceasing to operate, the RFID beginning to operate, or the RFID changing its frequency of transmission.

In another aspect of the present disclosure, which may be used in combination with any other aspect or combination of aspects listed herein, the electrical component is a capacitor which is part of an RFID tag, and an output of the RFID tag changes based on a change of capacitance of the capacitor caused by the indicator material.

In another aspect of the present disclosure, which may be used in combination with any other aspect or combination of aspects listed herein, the electrical property of the electrical component changes responsive to contact with the indicator material while the indicator material is in the liquid state.

In another aspect of the present disclosure, which may be used in combination with any other aspect or combination of aspects listed herein, the electrical property of the electrical component remains altered from the contact with the indicator material after the indicator material returns to the solid state.

In another aspect of the present disclosure, which may be used in combination with any other aspect or combination of aspects listed herein, the indicator material contacts the electrical component only if it is exposed to a temperature above a melting point of the indicator material for at least a predetermined period of time after the release of the indicator material from the microcapsules.

In another aspect of the present disclosure, which may be used in combination with any other aspect or combination of aspects listed herein, the temperature is above the predetermined melting point, but the temperature is maintained only for sufficiently long to release the indicator material without applying sufficient heat to melt the indicator material.

In another aspect of the present disclosure, which may be used in combination with any other aspect or combination of aspects listed herein, the microcapsules are further configured to release the indicator material in response to a first activation pressure being applied, and in response to a second activation pressure less than the first activation pressure is being applied at or above a predetermined activation temperature.

In another aspect of the present disclosure, which may be used in combination with any other aspect or combination of aspects listed herein, the activatable environmental indicator further comprises a wick on or in the substrate, the wick positioned to allow the indicator material to migrate along the wick towards the electrical component.

In another aspect of the present disclosure, which may be used in combination with any other aspect or combination of aspects listed herein, the microcapsules are configured to respond to the activation temperature and the activation pressure provided by a direct thermal print head.

In another aspect of the present disclosure, which may be used in combination with any other aspect or combination of aspects listed herein, the activation temperature is between 90° C. and 110° C.

In another aspect of the present disclosure, which may be used in combination with any other aspect or combination of aspects listed herein, the activation pressure is between 1.5 to 8 pounds per square inch.

In another aspect of the present disclosure, which may be used in combination with any other aspect or combination of aspects listed herein, the activation temperature is between 100° C. and 200° C. and the activation pressure is between 4 to 15 pounds per square inch.

In another aspect of the present disclosure, which may be used in combination with any other aspect or combination of aspects listed herein, the predetermined melting point is between 5° C. and 35° C.

In another aspect of the present disclosure, which may be used in combination with any other aspect or combination of aspects listed herein, the predetermined melting point is between-40° C. and 100° C.

In another aspect of the present disclosure, which may be used in combination with any other aspect or combination of aspects listed herein, the microcapsules comprise a gel.

In another aspect of the present disclosure, which may be used in combination with any other aspect or combination of aspects listed herein, the microcapsules comprise at least one component chosen from the list consisting of a protein, polyurea formaldehyde, polymelamine formaldehyde, a wax material, and an emulsion.

In another aspect of the present disclosure, which may be used in combination with any other aspect or combination of aspects listed herein, the microcapsules have an outer diameter length between 20 to 250 μm.

In another aspect of the present disclosure, which may be used in combination with any other aspect or combination of aspects listed herein, the microcapsules respond to at least one of the activation temperature and the activation pressure by fracturing, melting, breaking, dissolving, or becoming porous.

In another aspect of the present disclosure, which may be used in combination with any other aspect or combination of aspects listed herein, the microcapsules have at least a first wall and a second wall encapsulating the indicator material, wherein the first wall is configured to respond to at least one of the activation temperature and the activation pressure and the second wall is configured to respond to at least one of the activation temperature and the activation pressure, and wherein both walls must respond in order to release the indicator material.

In another aspect of the present disclosure, which may be used in combination with any other aspect or combination of aspects listed herein, an activatable indicator material comprises a polar protic organic material having a predetermined melting point and a plurality of microcapsules encapsulating the polar protic organic material in a solid state. The microcapsules retain the polar protic organic material when the polar protic organic material transitions to a liquid state while encapsulated and are configured to release the polar protic organic material in response to at least one of an activation temperature or an activation pressure.

In another aspect of the present disclosure, which may be used in combination with any other aspect or combination of aspects listed herein, the polar protic organic material is chosen from a list consisting of polyethylene glycol, acetic acid, methanol, ethanol, propanol, butanol, pentadecanol, hexanol, decanol, undecanol, dodecanol, and tridecanol.

In another aspect of the present disclosure, which may be used in combination with any other aspect or combination of aspects listed herein, the temperature is above the predetermined melting point, but the temperature is maintained only for sufficiently long to release the indicator material without applying sufficient heat to melt the indicator material.

In another aspect of the present disclosure, which may be used in combination with any other aspect or combination of aspects listed herein, the microcapsules are further configured to release the indicator material in response to a first activation pressure being applied, and in response to a second activation pressure less than the first activation pressure is being applied at or above a predetermined activation temperature.

In another aspect of the present disclosure, which may be used in combination with any other aspect or combination of aspects listed herein, the predetermined melting point is between 5° C. and 35° C.

In another aspect of the present disclosure, which may be used in combination with any other aspect or combination of aspects listed herein, the predetermined melting point is between-40° C. and 100° C.

In another aspect of the present disclosure, which may be used in combination with any other aspect or combination of aspects listed herein, the microcapsules comprise a gel.

In another aspect of the present disclosure, which may be used in combination with any other aspect or combination of aspects listed herein, the microcapsules comprise at least one component chosen from the list consisting of a protein, polyurea formaldehyde, polymelamine formaldehyde, a wax material, and an emulsion.

In another aspect of the present disclosure, which may be used in combination with any other aspect or combination of aspects listed herein, the microcapsules have an outer diameter length between 20 to 250 μm.

In another aspect of the present disclosure, which may be used in combination with any other aspect or combination of aspects listed herein, the microcapsules respond to at least one of the activation temperature and the activation pressure by fracturing, melting, breaking, dissolving, or becoming porous.

In another aspect of the present disclosure, which may be used in combination with any other aspect or combination of aspects listed herein, the microcapsules have at least a first wall and a second wall encapsulating the polar protic organic material, wherein the first wall is configured to respond to at least one of the activation temperature and the activation pressure and the second wall is configured to respond to at least one of the activation temperature and the activation pressure, and wherein both walls must respond in order to release the polar protic organic material.

In another aspect of the present disclosure, which may be used in combination with any other aspect or combination of aspects listed herein, a method of monitoring exposure to a predetermined environmental stimulus comprises the steps of providing a substrate and an activatable environmental indicator comprising an indicator material including a polar protic organic material having a predetermined melting point and a plurality of microcapsules configured to respond to at least one of an activation temperature and an activation pressure by allowing the polar protic organic material to be released from the microcapsules, wherein the microcapsules encapsulate the polar protic organic material in a solid state and retain the polar protic organic material in a liquid state; activating the polar protic organic material by exposing the microcapsule to the at least one of an activation temperature and an activation pressure, allowing the polar protic organic material to be released from the microcapsules, exposing the activatable environmental indicator to a predetermined environmental stimulus causing the polar protic organic material to travel along or through the substrate to cause a change in an electrical property of the electrical component, causing a change in an electrical property of the electrical component, and detecting an exposure of the predetermined environmental stimulus based on the change in the electrical property of the electrical component.

In another aspect of the present disclosure, which may be used in combination with any other aspect or combination of aspects listed herein, the method of monitoring exposure to a predetermined environmental stimulus further comprising exposing the activatable environmental indicator to the predetermined environmental stimulus so that the polar protic organic material melts.

In another aspect of the present disclosure, which may be used in combination with any other aspect or combination of aspects listed herein, the indicator material comprises a polymer having crystallinity.

In another aspect of the present disclosure, which may be used in combination with any other aspect or combination of aspects listed herein, the polar protic organic material is chosen from a list consisting of polyethylene glycol, acetic acid, methanol, ethanol, propanol, butanol, pentadecanol, hexanol, decanol, undecanol, dodecanol, and tridecanol.

In another aspect of the present disclosure, which may be used in combination with any other aspect or combination of aspects listed herein, the electrical component is a capacitor and the change of electric property is a change in capacitance of the capacitor.

In another aspect of the present disclosure, which may be used in combination with any other aspect or combination of aspects listed herein, the electrical component is a capacitance structure including multiple capacitors and the change of electrical property is a change of capacitance of the capacitance structure.

In another aspect of the present disclosure, which may be used in combination with any other aspect or combination of aspects listed herein, the electrical component is a resistor and the change of electric property is a change in resistance.

In another aspect of the present disclosure, which may be used in combination with any other aspect or combination of aspects listed herein, the electrical component is part of an RFID tag and the change in electrical property results in a change in information transmitted by the RFID tag, the RFID ceasing to operate, the RFID beginning to operate, or the RFID changing its frequency of transmission.

In another aspect of the present disclosure, which may be used in combination with any other aspect or combination of aspects listed herein, the electrical component is a capacitor which is part of an RFID tag, and an output of the RFID tag changes based on a change of capacitance of the capacitor caused by the indicator material.

In another aspect of the present disclosure, which may be used in combination with any other aspect or combination of aspects listed herein, the electrical property of the electrical component changes from the contact with the indicator material while the indicator material is in the liquid state.

In another aspect of the present disclosure, which may be used in combination with any other aspect or combination of aspects listed herein, the electrical property of the electrical component remains altered from the contact with the polar protic organic material after the polar protic organic material returns to the solid state.

In another aspect of the present disclosure, which may be used in combination with any other aspect or combination of aspects listed herein, responsive to a temperature returning below the predetermined melting point before a predetermined time, the polar protic organic material resolidifies and does not reach the electrical component.

In another aspect of the present disclosure, which may be used in combination with any other aspect or combination of aspects listed herein, the predetermined environmental stimulus is an exposure of the activatable environmental indicator to a temperature above the predetermined melting point after the release of the polar protic organic material.

In another aspect of the present disclosure, which may be used in combination with any other aspect or combination of aspects listed herein, the predetermined environmental stimulus is an exposure of the activatable environmental indicator to a temperature above a melting point of the polar protic organic material for at least a predetermined period of time after the release of the polar protic organic material.

In another aspect of the present disclosure, which may be used in combination with any other aspect or combination of aspects listed herein, the predetermined environmental stimulus is chosen from a list consisting of temperature excursion above a predetermined temperature threshold for at least a predetermined amount of time, temperature excursion below a predetermined temperature for at least a predetermined amount of time, and cumulative exposure to a predetermined temperature over a time period above a predetermined threshold for at least a predetermined amount of time.

In another aspect of the present disclosure, which may be used in combination with any other aspect or combination of aspects listed herein, the temperature is above the predetermined melting point, but the temperature is maintained only for sufficiently long to release the indicator material without applying sufficient heat to melt the indicator material.

In another aspect of the present disclosure, which may be used in combination with any other aspect or combination of aspects listed herein, the microcapsules are further configured to release the polar protic organic material in response to a first activation pressure being applied, and in response to a second activation pressure less than the first activation pressure is being applied at or above a predetermined activation temperature.

In another aspect of the present disclosure, which may be used in combination with any other aspect or combination of aspects listed herein, the method of monitoring exposure to a predetermined environmental stimulus further comprises a wick on or in the substrate, the wick positioned to allow the polar protic organic material to migrate along the wick towards the electrical component.

In another aspect of the present disclosure, which may be used in combination with any other aspect or combination of aspects listed herein, the microcapsules are configured to respond to the activation temperature and the activation pressure provided by a direct thermal print head.

In another aspect of the present disclosure, which may be used in combination with any other aspect or combination of aspects listed herein, the method of monitoring exposure to a predetermined environmental stimulus further comprises activating the activatable environmental indicator by applying the at least one of an activation temperature and an activation pressure using a direct thermal printer or a thermal transfer printer.

In another aspect of the present disclosure, which may be used in combination with any other aspect or combination of aspects listed herein, the method of monitoring exposure to a predetermined environmental stimulus further comprises printing an indicia on the substrate with the direct thermal printer or the thermal transfer printer.

In another aspect of the present disclosure, which may be used in combination with any other aspect or combination of aspects listed herein, the activation temperature is between 90° C. and 110° C.

In another aspect of the present disclosure, which may be used in combination with any other aspect or combination of aspects listed herein, the activation pressure is between 1.5 to 8 pounds per square inch.

In another aspect of the present disclosure, which may be used in combination with any other aspect or combination of aspects listed herein, wherein the activation temperature is between 100° C. and 200° C. and the activation pressure is between 4 to 15 pounds per square inch.

In another aspect of the present disclosure, which may be used in combination with any other aspect or combination of aspects listed herein, the predetermined melting point is between 5° C. and 35° C.

In another aspect of the present disclosure, which may be used in combination with any other aspect or combination of aspects listed herein, the predetermined melting point is between-40° C. and 100° C.

In another aspect of the present disclosure, which may be used in combination with any other aspect or combination of aspects listed herein, the microcapsules comprise a gel.

In another aspect of the present disclosure, which may be used in combination with any other aspect or combination of aspects listed herein, the microcapsules comprise at least one component chosen from the list consisting of a protein, polyurea formaldehyde, polymelamine formaldehyde, a wax material, and an emulsion.

In another aspect of the present disclosure, which may be used in combination with any other aspect or combination of aspects listed herein, the microcapsules have an outer diameter length between 20 to 250 μm.

In another aspect of the present disclosure, which may be used in combination with any other aspect or combination of aspects listed herein, the microcapsules respond to at least one of the activation temperature and the activation pressure by fracturing, melting, breaking, dissolving, or becoming porous.

In another aspect of the present disclosure, which may be used in combination with any other aspect or combination of aspects listed herein, the microcapsules have at least a first wall and a second wall encapsulating the indicator material, wherein the first wall is configured to respond to at least one of the activation temperature and the activation pressure and the second wall is configured to respond to at least one of the activation temperature and the activation pressure, and wherein both walls must respond in order to release the indicator material.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a diagram of an activatable environmental indicator according to an example embodiment of the present disclosure.

FIGS. 2A and 2B illustrate a cross-sectional views of a microcapsule containing an indicator material, according to an example of the present disclosure.

FIG. 3A is a chart including the melting points of various mixtures of 1-undecanol and 1-decanol, according to an example of the present disclosure.

FIG. 3B is a chart including the melting points of various mixtures of 1-tridecanol and 1-dodecanol, according to an example of the present disclosure.

FIGS. 4A and 4B are charts illustrating the heat flow and temperature of various polar protic materials, according to an example of the present disclosure.

FIGS. 5A, 5B, 5C, and 5D are various examples of a cross-sectional view of the activatable environmental indicator of FIG. 1 along the line of A-A.

FIG. 6 is a diagram of the activatable environmental indicator of FIG. 1 after the activatable environmental indicator is exposed to a temperature above a melting point of an indicator material.

FIGS. 7A, 7B, 7C, and 7D are various examples of a cross-sectional view of the activatable environmental indicator of FIG. 6 along the line of A-A after the activatable environmental indicator is exposed to a temperature above a melting point of an indicator material.

FIG. 8 is a diagram of an activatable environmental indicator according to an example embodiment of the present disclosure.

FIGS. 9A, 9B, and 9C are various examples of a cross-sectional view of the activatable environmental indicator of FIG. 8 along the line of B-B.

FIG. 10 is a diagram of the activatable environmental indicator of FIG. 8 after the activatable environmental indicator is exposed to a temperature above a melting point of an indicator material.

FIGS. 11A, 11B, and 11C are various examples of a cross-sectional view of the activatable environmental indicator of FIG. 10 along the line of B-B after the activatable environmental indicator is exposed to a temperature above a melting point an environmental indicator.

FIG. 12 is a diagram of an activatable environmental indicator according to an example embodiment of the present disclosure.

FIGS. 13A, 13B, and 13C are various examples of a cross-sectional view of the activatable environmental indicator of FIG. 10 along the line of B-B.

FIG. 14 is a diagram of the activatable environmental indicator of FIG. 12 after the activatable environmental indicator is exposed to a temperature above a melting point.

FIGS. 15A, 15B, and 15C are various examples of a cross-sectional view of the activatable environmental indicator of FIG. 14 along the line of B-B after the activatable environmental indicator is exposed to a temperature above a melting point.

FIG. 16 is a diagram of an activatable environmental indicator according to an example embodiment of the present disclosure.

FIG. 17 is a diagram of an activatable environmental indicator according to an example embodiment of the present disclosure.

FIG. 18 is a diagram of an activatable environmental indicator according to an example embodiment of the present disclosure.

FIG. 18 is a diagram of an activatable environmental indicator according to an example embodiment of the present disclosure.

FIG. 20 is a diagram of a radio frequency ID (RFID) tag system according to an example embodiment of the present disclosure.

FIG. 21 is a circuit diagram of the RFID tag system of FIG. 20.

FIG. 22 is an example process of assembling the RFID tag system of FIG. 20.

FIG. 23 illustrates a method of monitoring exposure to a predetermined environmental stimulus, according to an example embodiment of the present disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Many vaccines, drugs, foodstuffs, and other products are temperature-sensitive, or perishable, and can lose quality with time at rates that are influenced by ambient temperatures. To help mitigate problems associated with undesirable temperature conditions, an activatable environmental indicator can be associated with the vaccines, drugs, foodstuffs, or other host products that are thermally sensitive, to provide an alert to a health worker, or other end-user, that the products may have lost potency and possibly should not be used.

It may be desirable to have an indicator that reports historical temperature exposure, e.g., whether the temperature of the product has exceeded a melting point, which may damage certain products. In other situations, it may be desirable to have an indicator that reports if a product is above, or has recently exceeded, a melting point, somewhat analogous to a thermometer. These indicators may be provided in a variety of forms, e.g., optically readable indicators. One approach to this is to encapsulate the environmental indicator materials (e.g., in microcapsules) to prevent the environmental indicator materials and/or environmental sensors including the environmental indicator materials from reacting to the environment when the response condition is satisfied and to selectively activate the indicator materials and/or the environmental sensor including the environmental indicator material by rupturing the encapsulation to release the indicator materials as described herein and in concurrently filed related applications: U.S. patent application, titled “PRINTER ACTIVATABLE ENVIRONMENTAL SENSING THROUGH CHEMICAL ENCAPSULATION”, Attorney Docket No. 0820887.00357; U.S. patent application, titled “MEDIA PROCESSING DEVICE AND COMPONENTS FOR ACTIVATABLE MEDIA PLATFORMS”, Attorney Docket No. 0820887.00358; U.S. patent application, titled “MEDIA CONSTRUCTION TO FACILITATE USE OF ACTIVATABLE PLATFORM”, Attorney Docket No. 0820887.00359; and U.S. patent application, titled “RIBBON FOR USE IN PRODUCING PRINTER ACTIVATABLE INDICATORS”, Attorney Docket No. 0820887.00356.

In some embodiments, either alone or combination with such optical indicators, indicators that signal historical or current temperature with either an electrical signal or a radio signal, such as a signal provided by a RFID, may be provided. The implementation of such electrical or radio indicators may be facilitated by the use of capacitors or other electrical components that significantly change capacitance or other electrical property in response to temperature exposure above a threshold. In some cases, the response may be irreversible, i.e., the changed electrical property does not return to its original value after the threshold exposure ends.

In some examples, an activatable environmental indicator according to the present disclosure may include a capacitive structure including two conductive plates separated by a dielectric layer capable of holding charge. The capacitance structure can be introduced to an RFID tag containing a chip capable of reading capacitance values of that structure.

The activatable environmental indicator according to the present disclosure may also a mechanism to inhibit or delay the flow of an indicator material, e.g., a wicking mechanism, a capillary tube, or other structure which requires a substantial amount of time for the indicator material to pass through. For example, a porous channel/wick can be formed on or in a substrate. An indicator material (e.g., dielectric material) may be disposed at one end of this porous channel. In some examples, this indicator material may be in its solid state and undergo an environmental dependent phase change (e.g., to liquid) when exposed to a temperature above a melting point. When the indicator material undergoes a phase change, for example, from solid to liquid, it may begin to move up the channel/wick. When the indicator material comes into contact with the capacitive structure, a change in capacitance may be observed. When the phase change occurs and the indicator material moves up the channel/wick, time will pass before the indicator material can be moved into the capacitive structure, thereby having a timer ability.

In some examples, the activatable environmental indicator according to the present disclosure may function as a multi-response indicator. For example, the activatable environmental indicator may include multiple porous channels/wicks, and multiple indicator materials may be disposed in each channel (e.g., at one end thereof). The indicator material in each channel may undergo an environmental dependent phase change when exposed to a temperature above a melting point and begin to move up the channel. The indicator material in each channel may have a different melting point, thereby detecting exposure to various temperature levels.

As used herein, the term “activation event” is a treatment, e.g., the exposure to certain amount of heat and/or pressure that causes the activation material to cease preventing the activatable environmental indicator from operating. The activation event may include the application of heat to reach an activation temperature, the application of an activation pressure, or a combination thereof. The use of applied heat may reduce the amount of pressure required for activation as compared to activation without applied heat, or vice versa.

As used herein, the term “non-activated configuration” refers to a configuration in which the microcapsules fully encapsulate the activatable environmental indicator material inhibiting the operation of the indicator material so that the indicator material will not respond, or will respond only in a materially reduced manner, to the relevant predetermined environmental stimulus. The “activated configuration” refers to a configuration in which the indicator material is not fully contained within the microcapsules such that the indicator material will respond in its intended fashion to the relevant predetermined environmental stimulus, e.g., depending on the type of environmental indicator, either immediately upon exposure beyond a threshold, or over time, or over a rate dependent on amount of exposure.

As used herein, the term “activation device” is a device configured to selectively cause the microcapsules to transition from its non-activated configuration to its activated configuration.

As used herein, the term “print head” refers to a component of an example activation device that transfers heat and/or pressure to an activatable print medium in response to an instruction from the activation device.

As used herein, the term “predetermined environmental stimulus” is an environmental condition in which the indicator material is configured to respond. The predetermined environmental stimulus may include, but is not limited to, temperature excursion above a predetermined temperature threshold, temperature excursion above a predetermined temperature threshold for at least a predetermined amount of time, temperature excursion below a predetermined temperature for at least a predetermined amount of time, cumulative exposure to temperature above a predetermined threshold for at least a predetermined amount of time, exposure to a particular chemical, oxygen exposure, ammonia exposure, exposure to a particular chemical above a threshold concentration, exposure to a particular chemical above the threshold concentration for at least a predetermined amount of time, exposure to at least a predetermined amount of radiation of a particular type, ultraviolet light exposure, humidity exposure, exposure to a humidity level above a predetermined threshold, and exposure to a humidity level above a predetermined threshold for at least a predetermined amount of time.

As used herein, the term “indicator material” refers to a material that exhibits a detectable response after being released from the microcapsules when it is exposed to a predetermined environmental stimulus. The detectable response may include a color state change, a change in transparency, a change in hue, a change in an electrical property, a change in conductivity, a change in capacitance, movement of the environmental indicator material along a substrate, or combinations thereof. In some embodiments, the environmental indicator material is configured to undergo a continuous chemical or physical state change between an “initial state” and an “end state”. In some embodiments, the change of state may be a change in a property, e.g., an optical property, such as a reflectance value, saturation value, color value, color density value, optical density value or color hue value of the “reactive component” or an electrical property. Specifically, the state change (e.g., optical property change) may provide exposure information indicating an exposure to an environmental stimulus since the environmental exposure indicator was in the “activated configuration.”

### Activatable Environmental Indicator—Generally

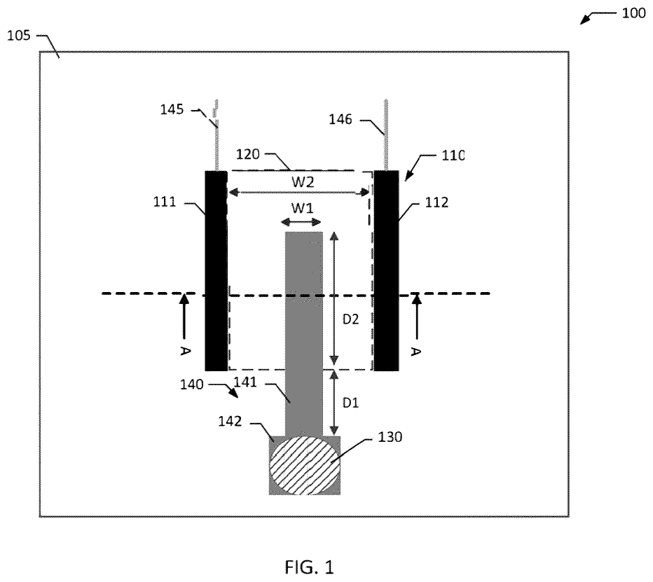

FIG. 1 depicts an example activatable environmental indicator 100 in accordance with one or more aspects of the present disclosure. The activatable environmental indicator 100 may include a capacitor 110 having a first electrode 111, a second electrode 112, and a gap 120 between the first electrode 111 and the second electrode 112. The gap between the electrodes may be an air gap, or may contain some dielectric material or a combination thereof. In some examples, the first electrode 111 may be connected to a first contact terminal 145, and the second electrode 112 may be connected to a second contact terminal 146. In some examples, the first electrode 111 and the second electrode 112 may be made with metal (e.g., copper, aluminum, silver, gold), graphite, conductive polymers, or any other suitable conducting materials.

In some examples, a substrate 105 may be provided, upon which the electrodes may be placed, deposited, or printed. In some examples, the substrate 105 may be made with a paper (e.g., TTC paper, WHATMAN filter paper). In other examples, the substrate 105 may be made with any other suitable nonconductive material, a film with a microchannel, or a breathable film, such as cloth or plastic (e.g., polyester, polyethylene terephthalate (PET), polyvinyl chloride (PVC), polyvinyl acetate (PVAC), etc.). The substrate 105 may also be the surface of a package for a product to be monitored, e.g., incorporating the feature directly in a box or other packing container, or a label material, e.g., an adhesive-backed label that may be applied to a package or product. In some examples, the activatable environmental indicator 100 may further include an indicator material 130 contained within microcapsules 135 which are in turn contained with a reservoir. Prior to activation, the indicator material 130 may be encapsulated in the microcapsules 135 which may prevent wicking, or migration of the indicator material 130, even if the indicator is exposed to a predetermined environmental stimulus that would cause wicking of the indicator material 130 if it were not encapsulated.

In some examples, the activatable environmental indicator 100 may further include a path 140 for the indicator material 130 to travel upon exposure to the predetermined environmental stimulus after the activation event. In some examples, the path 140 may include a reservoir 142 configured to hold the indicator material 130 and a channel portion 141 along which the indicator material 130 can migrate/diffuse into or along the gap 120. The path 140 may connect the indicator material 130 to the gap 120.

In some examples, the reservoir 142 (and the indicator material 130) may be disposed at one end of the path 140. In other examples, the reservoir 142 may be disposed at any other portion of the path 140 (e.g., in the middle portion of the channel portion 141). As shown in FIG. 1, the reservoir 142 (and the indicator material 130) may be disposed at a predetermined distance D1 away from the capacitor 110/gap 120.

In some examples, a length D2 of the channel portion 141 that is disposed between the first electrode 111 and the second electrode 112 may be at least 50% of the length of the first/second electrode 111/112, for example, at least 60%, at least 70%, at least 80%, at least 90, or at least 100%. In other examples, the length D2 of the channel portion 141 that is disposed between the first electrode 111 and the second electrode 112 may be less than 50% of the length of the first/second electrode 111/112, for example, less than 40%, less than 30%, or less than 20%. A length of the path 140 can correspond to a cumulative lengths of the predetermined distance/length D1 and the length D2 (D1+D2).

In some examples, the length D1 of the channel portion 141 that is disposed outside of the capacitor 110 may be at least 50% of the length of the first/second electrode 111/112, for example, at least 60%, at least 70%, at least 80%, at least 90, or at least 100%. In other examples, the length D2 of the channel portion 141 that is disposed between the first electrode 111 and the second electrode 112 may be less than 50% of the length of the first/second electrode 111/112, for example, less than 40%, less than 30%, or less than 20%.

In some examples, the length D1 or D2 of the channel portion 141 may be in a range of about 0.1 to 3 inches. In other examples, the length D1 or D2 of the channel portion 141 may have any other suitable value to provide the required amount of delay in the movement of the material from the reservoir to the gap (e.g., 0 to 0.5 inches or greater than 3 inches). In some examples, the thickness of the path 140 may be about 0.1 to about 0.5 mil, about 0.5 to about 1.5 mil, about 1.5 to about 5.0 mil, or about 5.0 to about 10.0 mil. In other examples, the path 140 may have any other suitable thickness. It will be appreciated that adjusting the lengths D1 and/or D2 may allow tuning the delay required for the movement of material.

In some examples, a width W1 of the channel portion 141 (e.g., average width) that is disposed between the first electrode 111 and the second electrode 112 may be at least 20% of the width W2 of the capacitor 110 (i.e., the distance between the first electrode 111 and the second electrode 112), for example, at least 30%, at least 40%, at least 50%, at least 60, at least 70%, at least 80%, at least 90%, or at least 100%. In other examples, the width W1 of the channel portion 141 (e.g., average width) that is disposed between the first electrode 111 and the second electrode 112 may be less than 20% of the width W2 of the capacitor, for example, less than 10%. It will be appreciated that adjusting the width W1 and/or adjusting a ratio or percentage of the width W1 to the width W2 may, in some cases, allow tuning the delay required for the movement of material.

In some examples, the width W1 of the channel portion 141 (e.g., average width) that is disposed between the first electrode 111 and the second electrode 112 may be in a range of about 0.1 to 1.5 inches. In other examples, the width W1 of the channel portion 141 (e.g., average width) that is disposed between the first electrode 111 and the second electrode 112 may have any other suitable value (e.g., less than 0.1 inches or greater than 1.5 inches). In some examples, the width W2 of the capacitor 110 may be in a range of about 0.1 to 3 inches. In other examples, the width W2 of the capacitor 110 may have any other suitable value (e.g., less than 0.1 inches or greater than 3 inches).

The change in capacitance of the activatable environmental indicator 100 may be irreversible. That is, once the capacitance has changed, the changed capacitance may persist after the activatable environmental indicator 100 is no longer exposed to the temperature above the melting point. After a change in capacitance and after a subsequent exposure to a temperature below the respective melting point, the activatable environmental indicator 100 may retain the changed capacitance or, if it does change it may not return all the way to its initial capacitance value.

In some examples, the indicator material 130 may migrate along the path 140 (e.g., the channel portion 141) and into or along the gap 120 in response to exposure to a temperature above a melting point. The migration of the indicator material 130 into or along the gap 120 may cause a change of the capacitance of the capacitor 110. For example, as the indicator material 130 is migrated into/along the gap 120, there may be a change in the dielectric constant of the gap portion 120 of the capacitor 110, thereby changing the capacitance of the capacitor 110/activatable environmental indicator 100 (e.g., capacitance increased from 5 to 10 pF). When the activatable environmental indicator 100 is associated with an RFID tag system, this may cause an integrated circuit of the RFID tag system to indicate the temperature change.

In some examples, when the path 140 (and the indicator material 130 after exposure to the temperature above the melting point, for example after an activation event when the indicator material 130 is encapsulated in the microcapsules 135,) fills/covers only a portion of the gap 120, the remaining space in the gap 120 may be filled with other filler material or component, including air, silicon dioxide, or any other suitable nonconductive material. In some examples, the filler material or component may be stable (e.g., tend not to change its dielectric constant) in response to a temperature change or other environmental conditions. In some examples, the change in the dielectric constant of the filler material due to the temperature change may be minimal compared to the change in capacitance due to the migration of the indicator material 130 into/along the gap 120. In some examples, the substrate 105 itself may be used as the filler material (e.g., the electrodes 111, 112 may be embedded in the substrate 105 and/or the substrate 105 may be etched and the electrodes 111, 112 may be placed in the etched channels so that the substrate 105 itself can be used as the filler material).

In some examples, at least a predetermined time period of exposure above the first melting point is required for the migration of the indicator material 130 to cause the change of the capacitance of the capacitor 110 after an initial exposure to the temperature above the melting point. Hereinafter, the predetermined time period is also called as a “response time,” and these terms will be used interchangeably throughout this application. As described above, the indicator material 130 may be disposed at a predetermined distance D1 away from the capacitor 110 and may start migrating along the path 140 (e.g., the channel portion 141) toward the capacitor 110 when exposed to the temperature above the melting point. Therefore, it may take time (e.g., the above-discussed predetermined time period) for the indicator material 130 to migrate into/along the gap 120. In some examples, there may be no change of the capacitance of the capacitor 110 when the activatable environmental indicator 100 is exposed to the temperature above the melting point less than the predetermined time period.

In some examples, there may be a sudden change in the capacitance of the activatable environmental indicator 100 when the indicator material 130 starts migrating/diffusing into the gap 120. However, once the indicator material 130 is already migrated/diffused into the gap 120, the capacitance of the activatable environmental indicator 100 may continue to substantially change as the temperature is maintained at a level above the melting point and/or as the exposure to the temperature above the melting point continues (for at least a certain amount of time, such as 2 hours, 5 hours, or 10 hours, for example, until the indicator material 130 is fully dispersed within the path 140). Therefore, at a different temperature level and/or exposure time, a capacitance value curve can be developed. This curve can be used to match the measured capacitance value to a corresponding temperature (e.g., temperature range), exposure time, or combination of both.

In some cases, the change in capacitance value may occur after a relatively long time period of exposure of the activatable environmental indicator 100 to a temperature above the melting point. In such cases, the change in capacitance value may occur after exposure of the activatable environmental indicator 100 for about 1 hour to about 72 hours to the temperature above the melting point, such as for about 1 hour to about 2 hours, for about 2 hours to about 5 hours, for about 5 hours to about 10 hours, for about 10 hours to about 24 hours, for about 24 hours to about 48 hours, or for about 48 hours to about 72 hours. The predetermined time period may be also in this time range. With a long time to change property in response to an exposure to the temperature above the threshold, the activatable environmental indicator 100 may be used as a time-temperature exposure indicator.

In some examples, the change in capacitance of the activatable environmental indicator may occur after a relatively shorter time period of exposure to the temperature above the melting point. In such cases, the change in capacitance can occur after exposure of the activatable environmental indicator 100 for about 1 minute to about 2 minutes, for about 2 minutes to about 5 minutes, for about 5 minutes to about 10 minutes, for about 10 minutes to about 30 minutes, for about 30 minutes to about 1 hour. The change in capacitance can also occur after exposure of the activatable environmental indicator 100 for about 1 minute or less to the temperature above the melting point, such as for about 30 seconds or less, for about 20 seconds or less, for about 15 seconds or less, for about 10 seconds or less, for about 5 seconds or less, or for about 2 seconds or less. The predetermined time period may be also in this time range. The materials for the indicator material 130 or the distance D1 of the channel portion 141 can be tuned, so that the melting point and the response time can be tied to properties of a perishable product. Shorter time periods may be particularly suitable for detecting products that have warmed up above a temperature—for example if they have been removed from a refrigerator and risen above a maximum allowed temperature that is close to the controlled temperature in the refrigerator. They may also be useful for products that only require a relatively short exposure to high temperature in order to be rendered unfit.

In some examples, the melting point can be about 55° C. to about 65° C., about 57.5° C. to about 62.5° C., about 45° C. to about 55° C., about 42.5° C. to about 47.5° C., about 35° C. to about 45° C., about 25° C. to about 35° C., about 27.5° C. to about 32.5° C., about 10° C. to about 25° C., about 0° C. to about 10° C., about −10° C. to about 0° C., about 65° C. or less, about 60° C. or less, about 55° C. or less, about 50° C. or less, about 45° C. or less, about 40° C. or less, about 35° C. or less, about 30° C. or less, about 25° C. or less, about 20° C. or less, about 15° C. or less, about 10° C. or less, about 0° C. or less, or about −10° C. or less. In other examples, the melting point can have any other suitable range.

In some examples, for vaccines (e.g., yellow fever vaccines, hepatitis vaccines, HPV vaccines, rotavirus vaccines, pneumococcal vaccines, cholera vaccines, etc.) that need to be stored between 2° C. and 8° C., the melting point can be about 8° C. In some examples, for medical supplies, diagnostics kits, and/or Controlled Temperature Chain (CTC) vaccines (e.g., MenAfriVac), the melting point can be about 40° C. In some examples, the melting point can be about 10° C. for blood, about 5° C. to about 8° C. for meats/leafy green vegetables, and about 34° C. for chocolate.

In some examples, for a given melting point, the amount of time that is required for the change in conductivity or capacitance/dielectric constant may depend on the difference between the real temperature (to which the activatable environmental indicator is exposed) and the given melting point. For example, when the difference between the real temperature and the given melting point is about 0° C., the amount of time that is required for the change in conductivity (e.g., response time) may be about 6 hours; when the difference is about 1° C., the response time may be about 3.5 hours; when the difference is about 2° C., the response time may be about 3 hours; and when the difference is about 5° C., the response time may be about 1 hour (and as the different increases, the response time may become flatter and flatter under 1 hour). In some examples, when the difference between the real temperature and the given melting point is about 0° C., response time may be about 75 minutes; when the difference is about 1° C., the response time may be about 45 minutes; when the difference is about 3° C., the response time may be about 20 minutes; and when the difference is about 5° C., the response time may be about 10 minutes.

### Microcapsules

The microcapsules 135 encapsulate the indicator material 130 in a solid state and retain the indicator material 130 as and after the indicator material 130 contained in the microcapsules 135 transitions to a liquid state in response to an environmental stimulus. Alternatively, e.g., if the stimulus is humidity or exposure to a particular gas, the microcapsules 135 may insulate the indicator material from the exposure. In either case, the indicator material is prevented from migrating prior to its release from the microcapsule, but after release is able to migrate in response to exposure to the relevant predetermined environmental exposure.

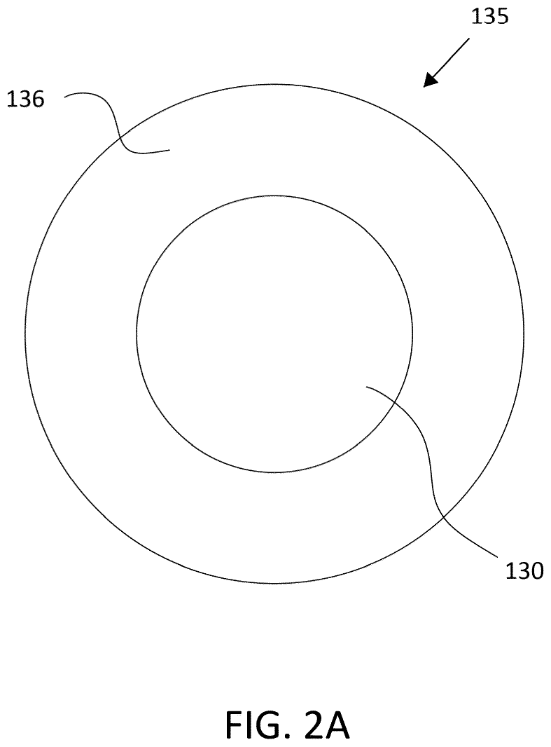

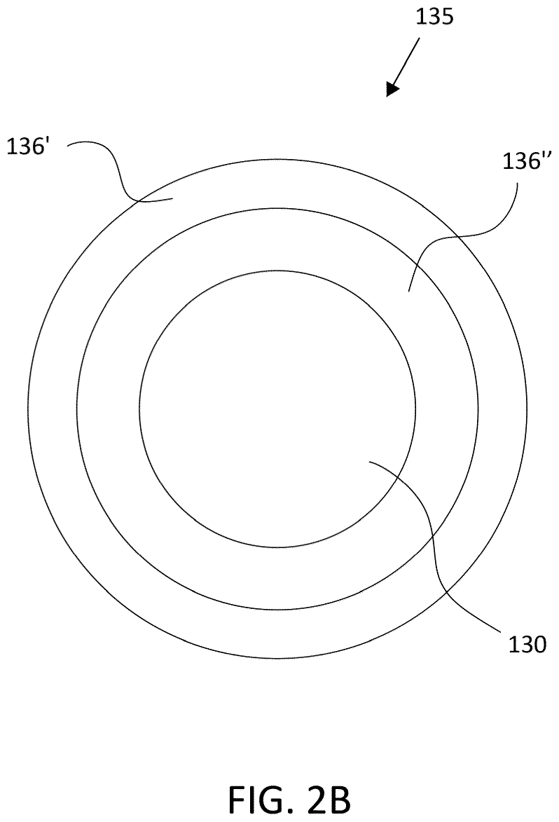

As shown in FIGS. 2A and 2B, the indicator material 130 is encapsulated by the microcapsules 135. FIG. 2A illustrates a cross-sectional view of a microcapsule 135 wherein the microcapsule 135 contains a shell 136 encapsulating an internal indicator material 130. The microcapsule 135 may be any size, but in one such embodiment, has an outer diameter length between 50 to 250 μm. The shell 136 of the microcapsule 135 may have any thickness, but in one such embodiment, has a thickness of between 5 to 25 μm. The payload, or the ratio of the total weight of the environmental indicator material 106 within the microcapsule 104 to the entire weight microcapsule 104 including the environmental indicator material 106 contained within the microcapsule 104, can range from 50% to 90%. It will be appreciated that a variety of microcapsule shell 136 materials may be chosen, depending on the application, the type of activation, and the nature of the indicator material 130. In general the microcapsules 135 should resist the passage, whether by flow, diffusion, or migration, of the indicator material prior to activation. For example, the microcapsules 135 may be a wax, e.g., an alkane wax, or other acid resistant compound having a relatively high melting point, e.g., fatty acid amide, an ester or Elvax EVA resin. For example, the predetermined melting point may be in a range of about 50° C. to about 300° C., from about 100° C. to about 300° C., from about 150° C. to about 300° C., from about 200° C. to about 300° C., from about 250° C. to about 300° C.

In another example, the microcapsules 135 may be polymer coating having a high glass transition temperature (Tg) e.g. Polysulfone. For example, the glass transition temperature may be in a range of about 50° C. to about 300° C., from about 100° C. to about 300° C., from about 150° C. to about 300° C., from about 200° C. to about 300° C., from about 250° C. to about 300° C. For example, polysulfone, with a Tg of about 190 C may be used. In additional examples, the microcapsules 135 may be one of Styrene Maleic Anhydride (SMA), Polyphenylene Ether (PPE), Cellulose Acetate, Cellulose Diacetate, Polyarylate, Polyamide, Polycarbonate, polyether ether ketone, Polyether Sulfone, PET, PFA, polymethyl methacrylate (PMMA) or Polyimide. In another example, the microcapsules 135 are a low molecular weight polymer gel having a high melting point, e.g., fatty acid amide, an ester or Elvax EVA resin. For example, the melting point may be in a range of about 100° C. to about 300° C., from about 150° C. to about 300° C., from about 200° C. to about 300° C., from about 250° C. to about 300° C. Additionally, in some examples, the polymer gel has a molecular weight in a range from about 1 g/mol to 100,000 g/mol, from about 3,500 g/mol to 6,000 g/mol and from about 200 g/mol to 2,000 g/mol. Alternatively, the microcapsules 135 may be a gel, protein, polyurea formaldehyde, polymelamine formaldehyde, wax material, melamine, or an emulsion. The microcapsules may be available in wet and dry formulations.

FIG. 2A illustrates a microcapsule 135 initially in an unactivated form, capable of being configured to transition to an activated form when activated through exposure to an activating event, e.g., the heat and/or heat and pressure of a thermal print head. The activating event may be the application of at least one of a heat to reach an activation temperature, an activation pressure, or a combination thereof. In the unactivated form, the microcapsule 135 maintains separation between the indicator material 130 and any external environmental stimuli. In some examples, the microcapsule 135 may be selectively removed, e.g., by fracturing, melting, breaking, dissolving, subliming, or becoming porous by activation.

The activatable environmental indicator 100 may be activated through exposure of the microcapsules 135 to an activation event. The activation event may include the application of heat to reach an activation temperature, the application of an activation pressure, or a combination thereof. In some examples, the temperature threshold for activation may be from about −40° C. to 100° C., from about 5° C. to 35° C., from about 0° C. to 300° C., from about 90° C. to 110° C., from about 100° C. to 200° C., from about 100° C. to 300° C., and from about 200° C. to 300° C. Activation may be achieved by applying a high temperature for a very short interval, e.g., a few milliseconds. In this manner, even if the temperature needed to activate the device exceeds the temperature that a temperature exposure indicator is configured to indicate, the exposure may be so short that the indicator itself is not affected. For example, the mass or heat of fusion of the indicator may be much greater than the mass or heat of fusion of a barrier that needs to be removed, allowing a short exposure to high temperature to remove or alter the microcapsule 135 without significantly affecting the indicator material 130 itself. Typical thermal print heads have temperatures in the range from about 100° C. to 300° C., which may be tuned downward for select applications to from about 100° C. to 200° C. They are typically exposed to the thermal print heads for a brief period of time, for example a few milliseconds. The microcapsules 135 itself responds when it reaches a temperature of in a range from about-40° C. to 100° C., from about 5° C. to 35° C., from about 0° C. to 300° C., from about 90° C. to 110° C., from about 100° C. to 200° C., from about 100° C. to 300° C., and from about 200° C. to 300° C. It will be appreciated that the activation temperature ranges given are purely exemplary and other ranges may be sufficient to activate the microcapsules 135, where such pressure ranges may vary based on a composition of the shell 136, a thickness of the shell 136, a ratio between the shell thickness or weight to volume or weight of the indicator material, a diameter of the microcapsules, a temperature applied to the shells, etc. In some cases, pressure may also contribute to the activation, e.g., by breaking microcapsules 135, either alone like an impact printer, or in combination with elevated temperature. In some examples, the activation pressure required to activate the microcapsules 135 may be from about 1.5 to 8 pounds per square inch or from about 4 to 15 pounds per square inch. It will be appreciated that the activation pressure ranges given are purely exemplary and other ranges may be sufficient to activate the microcapsules 135, where such pressure ranges may vary based on a composition of the shell 136, a thickness of the shell 136, a ratio between the shell thickness or weight to volume or weight of the indicator material, a diameter of the microcapsules, a temperature applied to the shells, etc.

In some examples, exposure to an activation event, the application of at least one of a heat and pressure, causes the microcapsules 135 to undergo a phase change and at least one of (i) flow away, (ii) sublimate, or (iii) become porous. In some examples, this may even result in complete or near-complete removal of the microcapsules 135. In other cases, portions of the microcapsules 135 may remain, e.g., as a porous layer that allows diffusion of the indicator material 130, or may rupture in response to pressure.

The activation event may be carried out using an activation device. In some examples, the activation device may be a device that includes a processor, a memory coupled to the processor and a thermal print head, e.g., a conventional thermal printer with software modifications.

In some embodiments, the microcapsule 135 may have two or more concentric shells 112 within a microcapsule 135 providing a barrier to the environmental exposure indicator material 130. FIG. 2B shows an embodiment with two separate shells, 136′, 136″, encapsulating the indicator material 106. Each shell 136′, 136″ may be configured to respond to a different activation event thus ensuring that the indicator material 130 is only released after or in response to exposure to more specific activation events. As one example, the first shell 136′ may be configured to respond to a certain activation pressure otherwise insulating the second shell 136″ from exposure to a certain activation temperature to which the second shell 136″ responds. As one example, the first shell 136′ may be configured to respond to a first activation pressure and/or temperature and the second shell 136″ may be configured to respond to a second pressure and/or temperature that is higher than the first pressure and/or temperature. In this regard, the utilization of multiple shells can tailor the order of conditions to which the environmental sensor print medium 100 be exposed in order to activate. A two shell indicator might release the material only if it has been exposed to both the required heat and pressure, but will not release in response to heat or pressure alone (at least to a certain minimum heat and pressure threshold).

### Indicator Material

The present disclosure includes an indicator material 130 encapsulated in the activatable microcapsules 104. The indicator material 130 provides an indication of the exposure of the activatable environmental indicator 100 to a predetermined environmental stimulus and/or provides an indication of duration of time elapsed since an activation event. In their initial non-activated configuration such as that shown in FIGS. 2A and 2B, the microcapsules 135 prevent the indicator material 130 from operating to provide the indication of exposure to the predetermined environmental stimulus, e.g. by preventing an environmental indicator material state change (e.g., by separating two materials that would otherwise interact, by keeping the environmental indicator materials from being exposed to the relevant predetermined environmental stimulus, by preventing movement, flow, or wicking of the indicator material after it changes to a mobile state, such as a liquid, or by hiding the indicator material (if the microcapsules were opaque and the indicator material color changes in response to environmental exposure). Upon activation, the indicator material 130 is exposed to the environment and thus is able to respond to the predetermined environmental stimulus when it occurs. As one such example, FIG. 2A illustrates an indicator material 130 contained within microcapsules 135 prior to an activation event.

The indicator material 130 is a polar protic material capable of exhibiting a detectable response upon the occurrence of a predetermined environmental stimulus. The polar protic material may comprise of any of the following: polyethylene glycol, acetic acid, methanol, ethanol, propanol, butanol, pentadecanol, hexanol, decanol, undecanol, dodecanol, tridecanol, ammonia, or any combination thereof. It will be appreciated that the polar protic materials listed are purely exemplary and any polar protic material may be utilized. In some examples, the polar protic material may be an organic material. In some examples, the polar protic material may also exhibit crystalline properties. Additives, for example colorants, viscosity altering agents, or other materials may also be combined with the polar protic material. In some examples, the indicator material 130 may be made of a solid with a melting point at or around the threshold which the indicator is to detect exposure to; at or around the melting point; a viscous material whose viscosity is low enough to prevent flow along the path 140 below the temperature excursion threshold, but whose viscosity allows flow along the path 140 above the threshold. In other examples, the indicator material 130 may be made of any other suitable nonconductive dielectric material that changes its state or viscosity so that it can flow along the path 140 when exposed to a temperature above the melting point.

Not wishing to be bound by theory, it is believed that after exposure to a melting point for a sufficient period of time, the polar protic material may melt and can flow along the path 140. As used herein, the term “melting temperature” or “melting point” may refer to the temperature at which a material exhibits peak unit heat absorption per degree Celsius, as determined by differential scanning calorimetry. Above its melting temperature, the material can exhibit liquid properties and below its melting temperature, the material can exhibit solid properties. As used herein, the term “melting temperature range” may refer to the temperature range from the melt onset temperature to the melting temperature of a material. As used herein, the term “melt onset temperature” may refer to the temperature at which the meltable material begins to exhibit an increase in unit heat absorption per degree Celsius, as determined by differential scanning calorimetry. Below its melt onset temperature, the material can be solid. The polar protic material can have a melting temperature close to the desired temperature excursion detection threshold of the activatable environmental indicator 100.

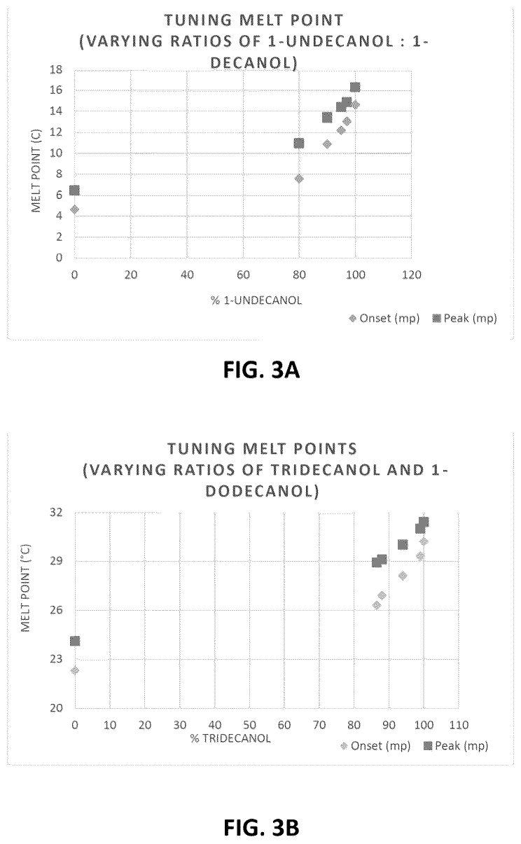

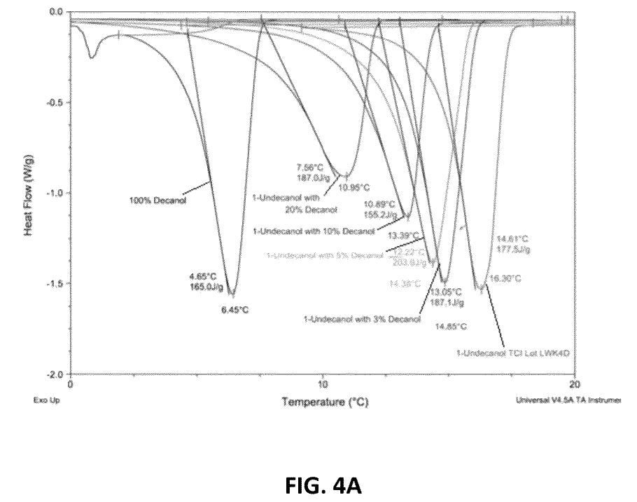

In some embodiments, the polar protic material may be chosen by the desired melting point. It will be appreciated that the performance of a device in terms of both the response temperature and the rate of flow may be tuned by using an appropriate mixture of materials, e.g., a combination of different polar protic solvents. As shown in FIGS. 3A and 3B, some desired polar protic materials may include 1-undecanol (having an outset melting point at 14.61° C. and a peak melting point at 16.30° C.); a mixture containing 97% 1-undecanol and 3% 1-decanol (having an outset melting point at 13.05° C. and a peak melting point at 14.85° C.); a mixture containing 95% 1-undecanol and 5% 1-decanol (having an outset melting point at 12.22° C. and a peak melting point at 14.38° C.); a mixture containing 90% 1-undecanol and 10% 1-decanol (having an outset melting point at 10.89° C. and a peak melting point at 13.39° C.); a mixture containing 80% 1-undecanol and 20% 1-decanol (having an outset melting point at 7.56° C. and a peak melting point at 10.95° C.); 1-decanol (having an outset melting point at 4.65° C. and a peak melting point at 6.45° C.); 1-tridecanol (having an outset melting point at 30.2° C. and a peak melting point at 31.4° C.); a mixture containing 99% 1-tridecanol and 1% 1-dodecanol (having an outset melting point at 29.3° C. and a peak melting point at 31.0° C.); a mixture containing 94% 1- tridecanol and 6% 1-dodecanol (having an outset melting point at 28.1° C. and a peak melting point at 30.0° C.); a mixture containing 88% 1-tridecanol and 12% 1-dodecanol (having an outset melting point at 26.9° C. and a peak melting point at 29.1° C.); a mixture containing 86.5% 1-tridecanol and 13.5% 1-dodecanol (having an outset melting point at 26.3° C. and a peak melting point at 28.9° C.); or 1-dodecanol (having an outset melting point at 22.3° C. and a peak melting point at 24.1° C.). In FIGS. 4A and 4B, the heat flow (W/g) is charted against melting point temperatures for various polar protic materials.

### Activatable Environmental Indicator Examples

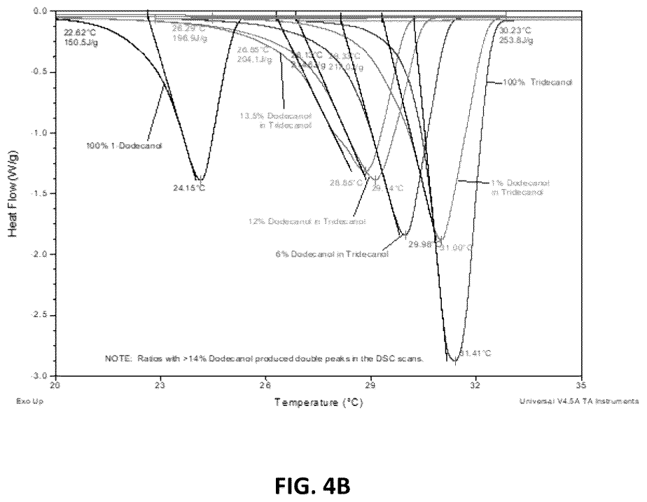

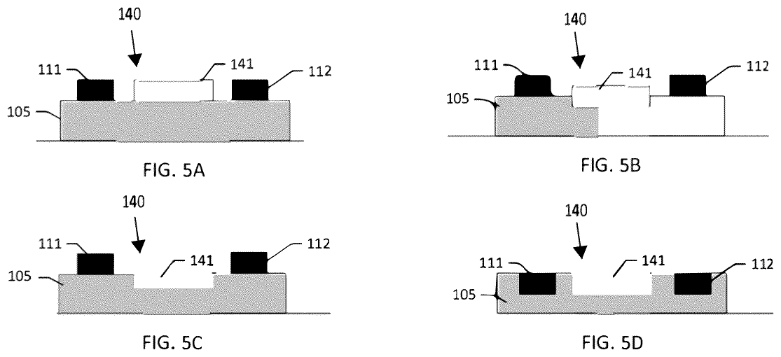

FIGS. 5A, 5B, 5C, and 5D show various examples of a cross-sectional view of the activatable environmental indicator of FIG. 1 along the line of A-A. In FIGS. 5A and 5B, the path 140 may be in the form of a cable, matrix, sponge, or web. In FIG. 5A, the path 140 is placed on the substrate 105. In FIG. 5B, the path 140 may be a combination of a groove and one of a cable, matrix, sponge, or web. That is, in FIG. 5B, a groove is formed on the substrate 105 and the cable, matrix, sponge, or web is placed on the groove. In FIGS. 5C and 5D, the path 140 may be in the form of a groove formed on the substrate 105. FIGS. 5A-C illustrate the first and second electrodes 111, 112 as being disposed on a surface of the substrate 105. However, the first and second electrodes can be embedded in or recessed with respect to the substrate 105. As an example, in FIG. 5D, the first and second electrodes 111 and 112 are shown as being disposed in the substrate 105. In one example, the substrate 105 may be etched and the electrodes 111, 112 may be placed in the etched channels to dispose the electrodes 111, 112 in the substrate 105.

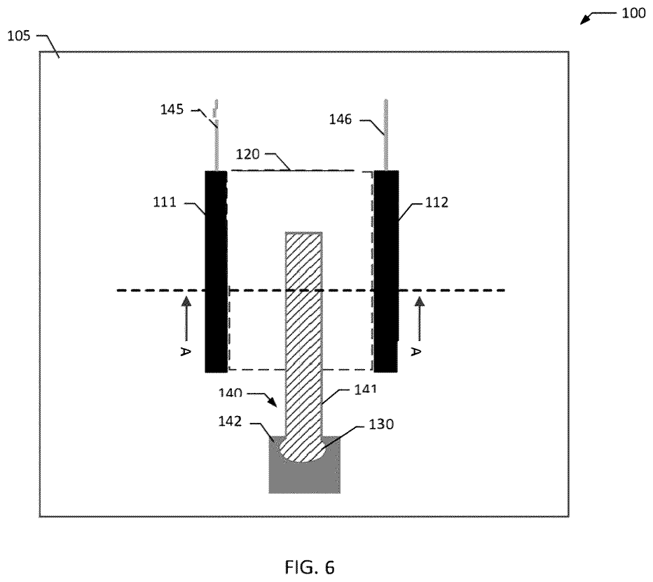

FIG. 6 illustrates the activatable environmental indicator of FIG. 1 after the activatable environmental indicator is activated and exposed to a predetermined environmental stimulus such as a temperature above the melting point (for example, for least the predetermined time period). In FIG. 6, the indicator material 130 migrates/diffuses along the path 140 (e.g., the channel portion 141) and into/along the gap 120.

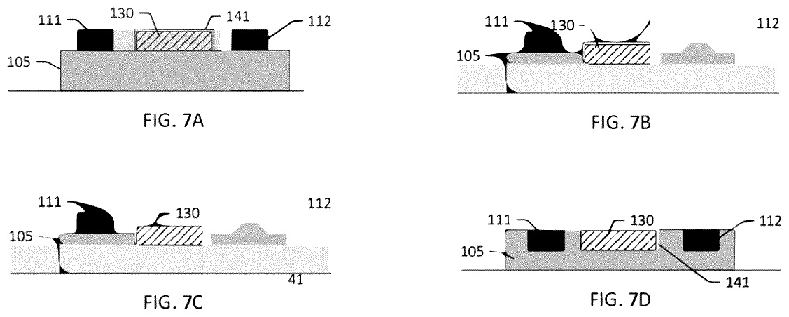

FIGS. 7A, 7B, 7C, and 7D show the various examples of a cross-sectional view of the activatable environmental indicator of FIG. 6 along the line of A-A after the activatable environmental indicator is exposed to a temperature above the melting point. After the migration/diffusion, the indicator material 130 (at least a portion thereof) is disposed between the first electrode 111 and the second electrode 112, thereby changing the capacitance of the capacitor 110/activatable environmental indicator 100.

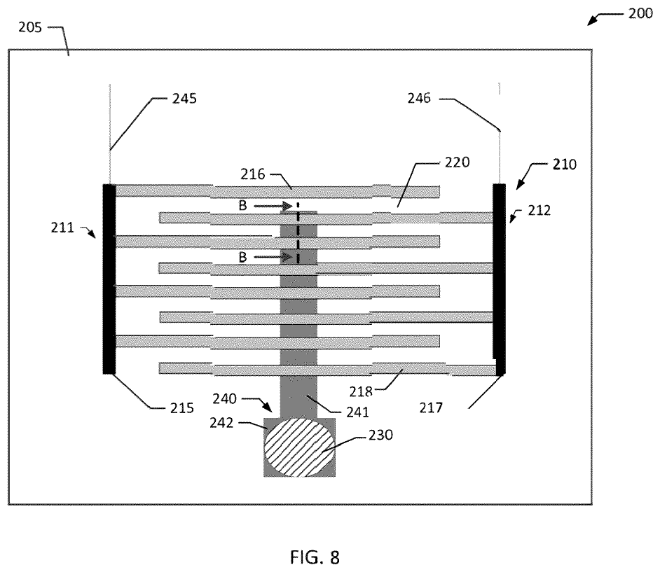

FIG. 8 is a diagram of an activatable environmental indicator 200 according to an example embodiment of the present disclosure. The activatable environmental indicator 200 may include a capacitor 210 having a first electrode 211, a second electrode 212, a gap 220 between the first electrode 211 and the second electrode 212. In some examples, the first electrode 211 may be connected to a first contact terminal 245, and the second electrode 212 may be connected to a second contact terminal 246. In some examples, a substrate 205 may be provided, and the activatable environmental indicator 200 may be disposed on or in the substrate 205.

In the activatable environmental indicator 200, the first electrode 211 and the second electrode 212 may be in a comb shape and interleaved with each other. For example, the first electrode 211 may include a first base plate 215 and plurality of first sub-electrodes 216 extending from the first base plate 215, and the second electrode 212 may include a second base plate 217 and plurality of second sub-electrodes 218 extending from the second base plate 217. The gap 220 may be formed between the first base plate 215 and the plurality of first sub-electrodes 216 of the first electrode 211 and the second base plate 217 and the plurality of second sub-electrodes 218 of the second electrode 212.

In some examples, the activatable environmental indicator 200 may further include an indicator material 230 encapsulated in the microcapsules 135 and a path 240 for the indicator material 230. In some examples, the path 240 may include a reservoir 242 configured to hold the encapsulated indicator material 230 and a channel portion 241 through which the indicator material 230 is configured to move once the microcapsules 135 are activated. The path 240 may connect the indicator material 230 to the gap 220.

In some examples, the indicator material 230 may be configured to migrate/diffuse along the path 240 (e.g., the channel portion 241) and into or along the gap 220 after an activation event and in response to exposure to a temperature above a melting point. The migration of the indicator material 230 into or along the gap 220 may cause a change of the capacitance of the capacitor 210. As the indicator material 230 is migrated/diffused into/along the gap 220, there may be a change in the dielectric constant of the portion of the gap 220, thereby changing the capacitance of the activatable environmental indicator 200. When the activatable environmental indicator 200 is associated with an RFID tag system, this may cause an integrated circuit of the RFID tag system to indicate the temperature change.

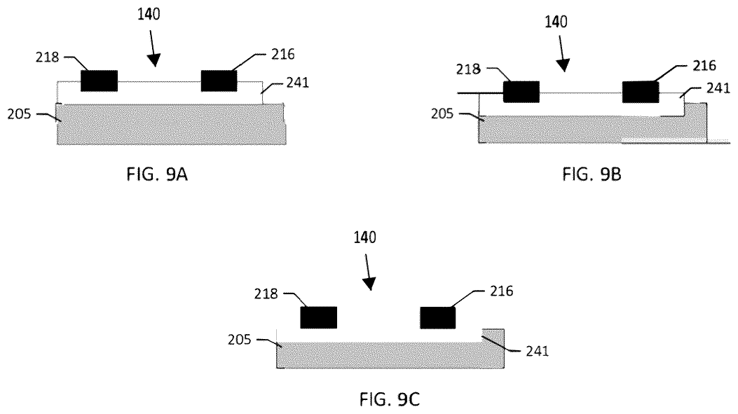

In some examples, the path 240 (e.g., the channel portion 241) may be disposed below the capacitor (e.g., the sub-electrodes 216, 218), and some portions of the channel portions 241 are disclosed between the sub-electrodes 216, 218. FIGS. 9A, 9B, and 9C show various examples of a cross-sectional view of the activatable environmental indicator of FIG. 8 along the line of B-B. As shown in FIGS. 9A, 9B, and 9C, the channel portion 241 is disposed below the sub-electrodes 216, 218, and some portions of the channel portions 241 are disclosed between the sub-electrodes 216, 218.

In FIGS. 9A and 9B, the path 240 may be in the form of a cable, matrix, sponge, or web. In FIG. 9A, the path 240 is placed on the substrate 205. In FIG. 9B, the path 240 may be a combination of a groove and one of a cable, matrix, sponge, or web. That is, in FIG. 9B, a groove is formed on the substrate 205 and the cable, matrix, sponge, or web is placed on the groove. In FIG. 9C, the path 240 may be in the form of a groove formed on the substrate 205.

Other configurations/features/characteristics of the activatable environmental indicator 200 (e.g., indicator material, filer material, melting point, reversibility, color change, response time, material, size of the components, etc.) may be similar to and/or same as the ones described above with respect to the activatable environmental indicator 100, and, thus, duplicate description may be omitted.

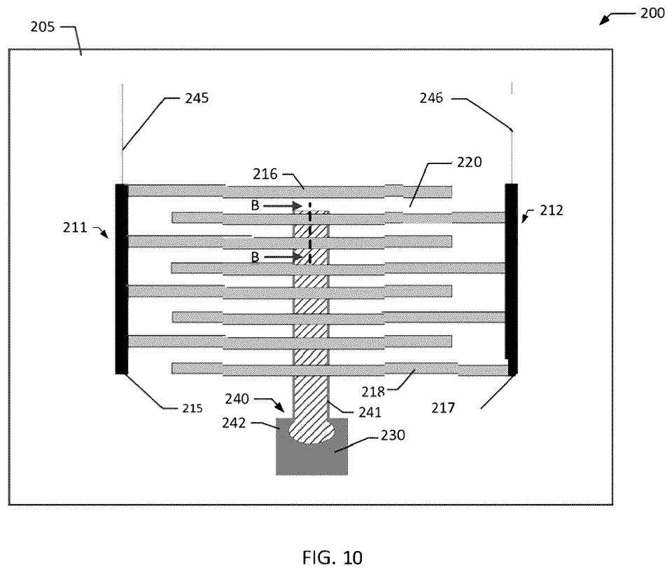

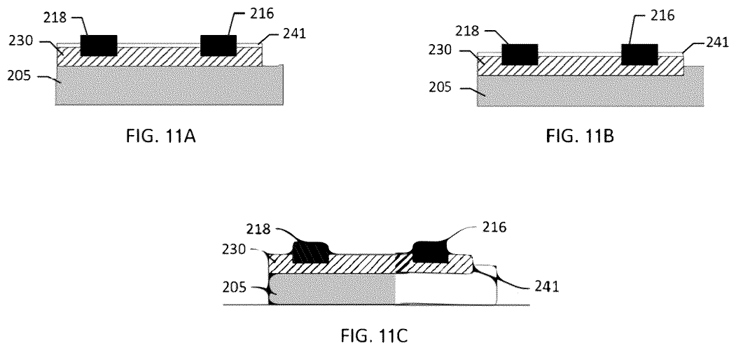

FIG. 10 illustrates the activatable environmental indicator 200 of FIG. 8 after the activatable environmental indicator 200 is activated in response to an activation event and exposed to a temperature above the melting point. In FIG. 10, the indicator material 230 is released from the microcapsules 135 and migrates/diffuses along the path 240 (e.g., the channel portion 241) and into or along the gap 220. FIGS. 11A, 11B, and 11C show the various examples of a cross-sectional view of the activatable environmental indicator of FIG. 10 along the line of B-B after the activatable environmental indicator is exposed to a temperature above the melting point. After the migration/diffusion, the indicator material 230 is disposed between the first sub-electrode 216 and the second sub-electrode 218, thereby changing the capacitance of the capacitor 210/activatable environmental indicator 200.

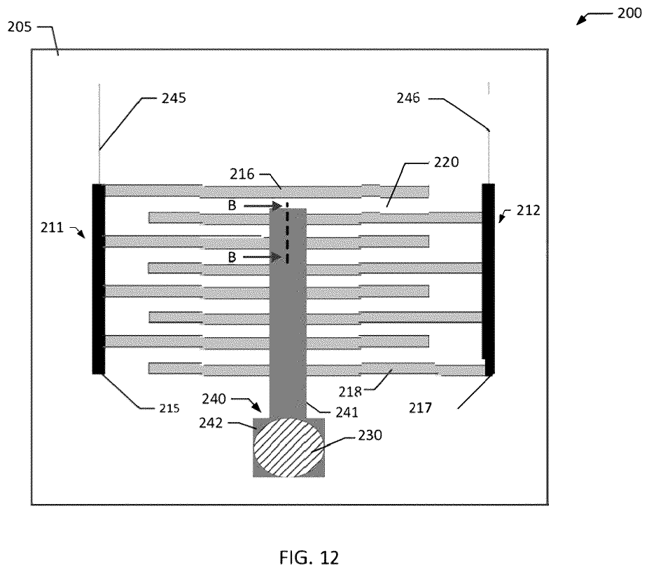

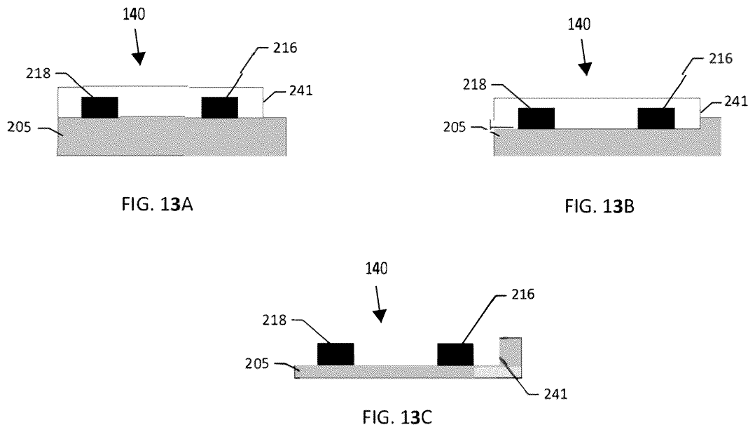

As shown in FIG. 12, in some examples, the path 240 (e.g., the channel portion 241) may be disposed above the capacitor 210 (e.g., the sub-electrodes 216, 218), and some portions of the channel portions 241 are disclosed between the sub-electrodes 216, 218. FIGS. 13A, 13B, and 13C show various examples of a cross-sectional view of the activatable environmental indicator 200 of FIG. 12 along the line of B-B. As shown in FIGS. 13A, 13B, and 13C, the channel portion 241 is disposed above the sub-electrodes 216, 218, and some portions of the channel portions 241 are disclosed between the sub-electrodes 216, 218.

In FIGS. 13A and 13B, the path 240 may be in the form of a cable, matrix, sponge, or web. In FIG. 13A, the path 240 is placed on the substrate 205. In FIG. 13B, the path 240 may be a combination of a groove and one of a cable, matrix, sponge, or web. That is, in FIG. 13B, a groove is formed on the substrate 205 and the cable, matrix, sponge, or web is placed on the groove. In FIG. 13C, the path 240 may be in the form of a groove formed on the substrate 205.

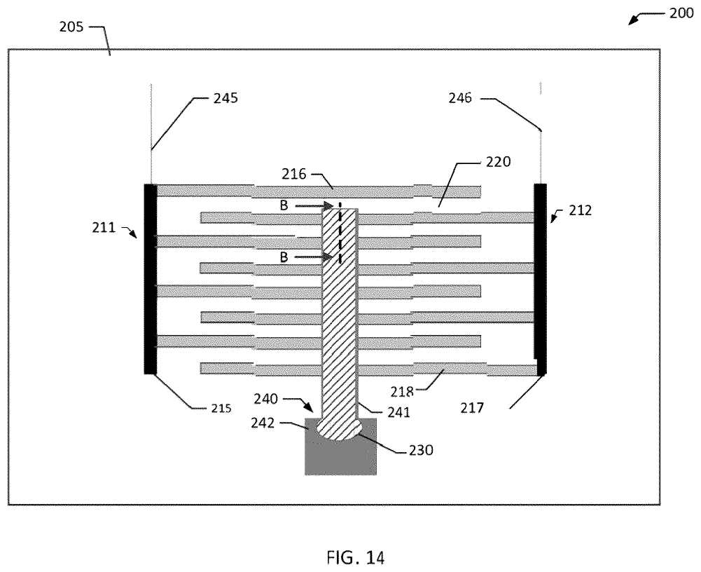

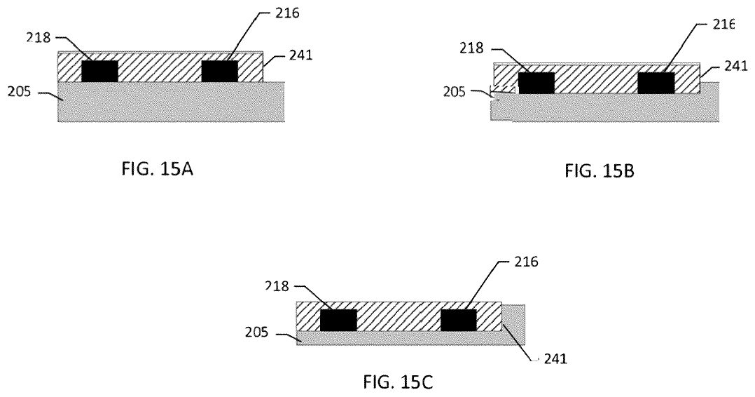

FIG. 14 illustrates the activatable environmental indicator 200 of FIG. 12 after the activatable environmental indicator 200 is activated in response to an activation event and exposed to a temperature above the melting point (for example, for at least the predetermined time period). In FIG. 14, the indicator material 230 is released from the microcapsules 135 and migrates/diffuses along the path 240 (e.g., the channel portion 241) and into or along the gap 220. FIGS. 15A, 15B, and 15C show various examples of a cross-sectional view of the activatable environmental indicator of FIG. 14 along the line of B-B after the activatable environmental indicator 200 is exposed to a temperature above the melting point. After the migration, the indicator material 230 is disposed between the first sub-electrode 216 and the second sub-electrode 218, thereby changing the capacitance of the capacitor 210/activatable environmental indicator 200.

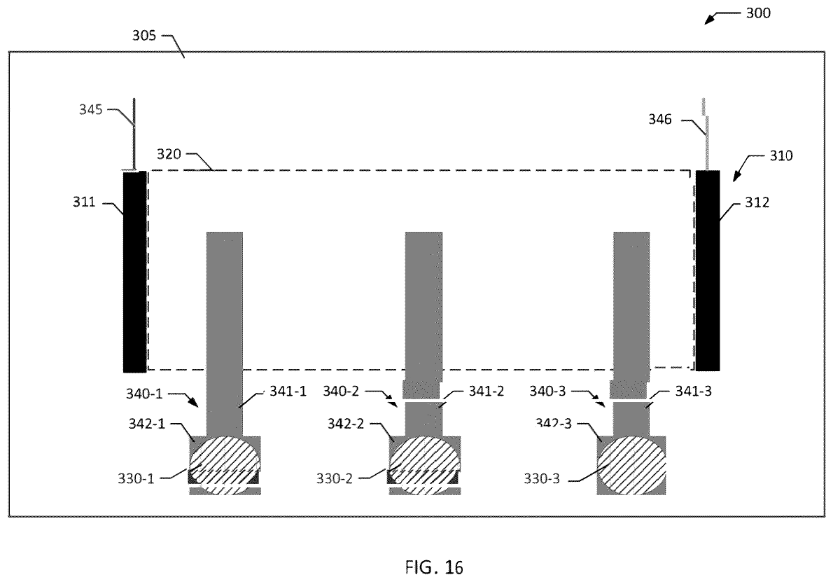

FIG. 16 is a diagram of an activatable environmental indicator 300 according to an example embodiment of the present disclosure. The activatable environmental indicator 300 may include a capacitor 310 having a first electrode 311, a second electrode 312, a gap 320 between the first electrode 311 and the second electrode 312. In some examples, the first electrode 311 may be connected to a first contact terminal 345, and the second electrode 312 may be connected to a second contact terminal 346. In some examples, a substrate 305 may be provided, and the activatable environmental indicator 300 may be disposed on or in the substrate 305.

In some examples, the activatable environmental indicator 300 may include a plurality of encapsulated indicator materials and/or paths. For example, the activatable environmental indicator 300 may include a first indicator material 330-1 and a first path 340-1, a second indicator material 330-2 and a second path 340-2, and a third indicator material 330-3 and a third path 340-3. Although there are three indicator materials and paths shown in FIG. 16, there could be more or less than three indicator materials and paths (e.g., 2, 4, 5, 6, 7 . . . ).

Each of the paths 340-1, 340-2, 340-3 may include a respective reservoir 342-1, 342-2, 342-3 configured to hold the respective encapsulated indicator material 330-1, 330-2, 330-3 and a channel portion 341-1, 341-2, 341-3 through which the respective indicator material 330-1, 330-2, 330-3 can migrate/diffuse into or along the gap 320 after an activation event that releases the indicator material 330-1, 330-2, 330-3 from the microcapsules 135 and the indicator material 330-1, 330-2, 330-3 is exposed to temperatures above its respective melting point. The paths 340-1, 340-2, 340-3 may connect the indicator material 330-1, 330-2, 330-3 to the gap 320.

The first indicator material 330-1 may migrate along the first path 340-1 and into or along the gap 320 after being released from the microcapsules 135 and in response to exposure to a temperature above a first melting point. The second indicator material 330-2 may migrate along the second path 340-2 and into or along the gap 320 after being released from the microcapsules 135 in response to exposure to a temperature above a second melting point. The third indicator material 330-3 may migrate along the second path 340-3 and into or along the gap 320 after being released from the microcapsules 135 in response to exposure to a temperature above a third melting point. In some examples, the indicator materials 330-1, 330-2, 330-3 may have a melting point that is different from each other. For example, the second melting point (e.g., 50° C.) may be greater than the first melting point (e.g., 35° C.), and the third melting point (e.g., 65° C.) may be greater than the second melting point. In some examples, the distance between the capacitor 310 (e.g., gap 320) and each of the indicator materials 330-1, 330-2, 330-3 may be the same as each other.

In some examples, the indicator materials 330-1, 330-2, 330-3 may have a melting point that is the same as each other. In this case, the distance between the capacitor 310 and each of the indicator materials 330-1, 330-2, 330-3 may be different from each other. For example, the first indicator material 330-1 (and the first reservoir 342-1) may be disposed at a first predetermined distance away from the capacitor 310/gap 320, the second indicator material 330-2 (and the second reservoir 342-2) may be disposed at a second predetermined distance away from the capacitor 310/gap 320, and the third indicator material 330-3 (and the third reservoir 342-3) may be disposed at a third predetermined distance away from the capacitor 310/gap 320. The second predetermined distance may be greater than the first predetermined distance, and the third predetermined distance may be greater than the second predetermined distance. In this case, the first, second, and third indicator materials 330-1, 330-2, 330-3 may start migrating along the respective path and into or along the gap 320 in response to exposure to a temperature above the same melting point, but since the distance between the capacitor 310/gap 320 and each indicator material is different, each indicator material may arrive at the gap 320 at a different time. In this way, the activatable environmental indicator 300 can detect the amount of time (e.g., range of time) for which the activatable environmental indicator 300 was exposed to the temperature above the melting point more accurately, and the exposure time can be calibrated in this way.

For example, at least the first, second, and third predetermined time periods (e.g., 2 hours, 4 hours, and 6 hours, respectively) of exposure above the melting point may be required for the migration of the first, second, and third indicator materials 330-1, 330-2, 330-3, respectively, to cause the change of the capacitance of the capacitor 310 after an initial exposure to the temperature above the melting point. When the capacitance change of the activatable environmental indicator 300 indicates that the capacitance change is due to the migration of only the first indicator material 330-1, the system/user can determine that the activatable environmental indicator 300 was exposed to the temperature above the melting point for more than the first predetermined time period (e.g., 2 hours) but less than the second predetermined time period (e.g., 4 hours).

In the above example, the indicator materials 330-1, 330-2, 330-3 have different response times by configuring the activatable environmental indicator 300 to have a different distance between the capacitor 310/gap 320 and each of the indicator materials 330-1, 330-2, 330-3. In some examples, the width of each of the paths 340-1, 340-2, 340-3 can be tuned (for example, while the length of each path is the same as each other) so that they have a different width from each other, thereby having different response times. For example, the width of the second path 340-2 may be greater than the width of the first path 340-1, and the width of the third path 340-3 may be greater than the width of the second path 340-2. In this case, the response time of the second dielectric material 330-2/second path 340-2 may be greater than the response time of the first dielectric material 330-1/first path 340-1, and the response time of the third dielectric material 330-3/third path 340-3 may be greater than the response time of the second dielectric material 330-2/second path 340-2. In other examples, the materials for the indicator materials 330-1, 330-2, 330-3 can be tuned, so that they have different flow rates/viscosity when exposed to a temperature above the melting point, thereby having different response times. In this case, the distance between the gap 320 and each of the indicator materials 330-1, 330-2, 330-3 may be the same as each other.

In some examples, the indicator materials 330-1, 330-2, 330-3 may have different melting points and different predetermined time periods. For example, the first indicator material 330-1 may migrate along the first path 340-1 and into or along the gap 320 in response to exposure to a temperature above a first melting point (e.g., 35° C.) after a first predetermined time period (2 hours) of exposure above the first melting point. The second indicator material 330-2 may migrate along the second path 340-2 and into or along the gap 320 in response to exposure to a temperature above a second melting point (e.g., 50° C.) after a second predetermined time period (e.g., 4 hours) of exposure above the second melting point. The third indicator material 330-3 may migrate along the third path 340-3 and into or along the gap 320 in response to exposure to a temperature above a third melting point (e.g., 65° C.) after a third predetermined time period (e.g., 6 hours) of exposure above the second melting point.

In some examples, only one of the melting point and the response time may be the same for all indicator materials 330-1, 330-2, 330-3. For example, the first indicator material 330-1 may migrate along the first path 340-1 and into or along the gap 320 in response to exposure to a temperature above a first melting point (e.g., 35° C.) after a first predetermined time period (2 hours) of exposure above the first melting point. The second indicator material 330-2 may migrate along the second path 340-2 and into or along the gap 320 in response to exposure to a temperature above a second melting point (e.g., 50° C.) after the first predetermined time period (e.g., 2 hours) of exposure above the second melting point. The third indicator material 330-3 may migrate along the third path 340-3 and into or along the gap 320 in response to exposure to a temperature above a third melting point (e.g., 65° C.) after the first predetermined time period (e.g., 2 hours) of exposure above the second melting point.

In some examples, the first indicator material 330-1 may migrate along the first path 340-1 and into or along the gap 320 in response to exposure to a temperature above a first melting point (e.g., 35° C.) after a first predetermined time period (2 hours) of exposure above the first melting point. The second indicator material 330-2 may migrate along the second path 340-2 and into or along the gap 320 in response to exposure to a temperature above the first melting point (e.g., 35° C.) after a second predetermined time period (e.g., 4 hours) of exposure above the first melting point. The third indicator material 330-3 may migrate along the third path 340-3 and into or along the gap 320 in response to exposure to a temperature above the first melting point (e.g., 35° C.) after a third predetermined time period (e.g., 6 hours) of exposure above the first melting point.

Other configurations/features/characteristics of the activatable environmental indicator 300 (e.g., indicator material, filer material, melting point, reversibility, color change, response time, material, size of the components, cross-sectional views, etc.) may be similar to and/or same as the ones described above with respect to the activatable environmental indicator 100, and, thus, duplicate description may be omitted.

In some examples, the activatable environmental indicator 300 may include a plurality of capacitors (each having a first electrode, a second electrode, a gap between the first electrode and the second electrode). Each of the capacitors may include at least one indicator material and at least one path. For example, the first indicator material 330-1 and the first path 340-1 may be matched with a first capacitor, the second indicator material 330-2 and the second path 340-2 may be matched with second capacitor, and the third indicator material 330-3 and the third path 340-3 may be matched with a third capacitor. In some examples, each capacitor may be considered as a separate sub-indicator, and connected to the RFID chip (e.g., integrated circuit 620) separately, and the RFID chip may detect capacitance value/change of the each sub-indicator, for example, to determine whether the respective melting point/response time of each capacitor has been exceeded.

Other configurations/features/characteristics of the activatable environmental indicator 300 when it has multiple capacitors (e.g., indicator material, filer material, melting point, reversibility, color change, response time, material, size of the components, cross-sectional views, or different/same melting point, response time, or path length/width between multiple indicator materials and/or paths, etc.) may be similar to and/or same as the ones described above with respect to the activatable environmental indicator 300, and, thus, duplicate description may be omitted.

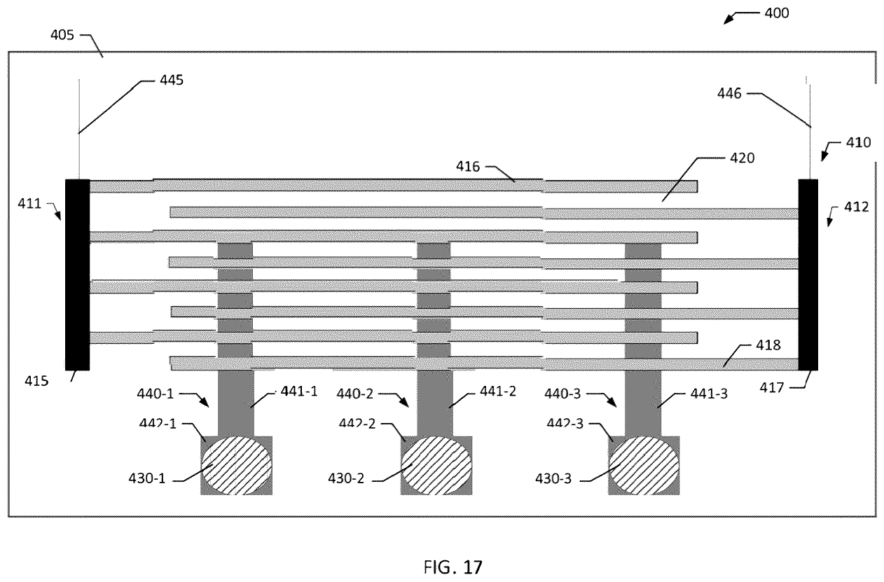

FIG. 17 is a diagram of an activatable environmental indicator 400 according to an example embodiment of the present disclosure. The activatable environmental indicator 400 may include a capacitor 410 having a first electrode 411, a second electrode 412, a gap 420 between the first electrode 411 and the second electrode 412. In some examples, the first electrode 411 may be connected to a first contact terminal 445, and the second electrode 412 may be connected to a second contact terminal 446. In some examples, a substrate 405 may be provided, and the activatable environmental indicator 400 may be disposed on or in the substrate 405.

In the activatable environmental indicator 400, the first electrode 411 and the second electrode 412 may be in a comb shape and interleaved with each other. For example, the first electrode 411 may include a first base plate 415 and plurality of first sub-electrodes 416 extending from the first base plate 415, and the second electrode 412 may include a second base plate 417 and plurality of second sub-electrodes 418 extending from the second base plate 417. The gap 420 may be formed between the first base plate 415 and the plurality of first sub-electrodes 416 of the first electrode 411 and the second base plate 417 and the plurality of second sub-electrodes 418 of the second electrode 412.

Similar to the activatable environmental indicator 300, in some examples, the activatable environmental indicator 400 may include a plurality of encapsulated indicator materials and/or paths. For example, the activatable environmental indicator 400 may include a first indicator material 430-1 and a first path 440-1, a second indicator material 430-2 and a second path 440-2, and a third indicator material 430-3 and a third path 440-3. Although there are three indicator materials and paths shown in FIG. 17, there could be more or less than three indicator materials and paths (e.g., 2, 4, 5, 6, 7 . . . ).

Each of the paths may include a reservoir 442-1, 442-2, 442-3 configured to hold the encapsulated indicator material 430-1, 430-2, 430-3 and a channel portion 441-1, 441-2, 441-3 through which the indicator material 430-1, 430-2, 430-3 can migrate/diffuse into or along the gap 420 after an activation event that releases the indicator material 430-1, 430-2, 430-3 from the microcapsules 135 and the indicator material 430-1, 430-2, 430-3 is exposed to temperatures above its respective melting point. The paths 440-1, 440-2, 440-3 may connect the indicator material 430-1, 430-2, 430-3 to the gap 420.

In some examples, the first indicator material 430-1 may migrate along the first path 440-1 and into or along the gap 420 after an activation event and in response to exposure to a temperature above a first melting point for at least a first predetermined time period. The second indicator material 430-2 may migrate along the second path 440-2 and into or along the gap 420 after an activation event and in response to exposure to a temperature above a second melting point for at least a second predetermined time period. The third indicator material 430-3 may migrate along the third path 440-3 and into or along the gap 420 after an activation event and in response to exposure to a temperature above a third melting point for a third predetermined time period. In some examples, the first, second, and third melting points may be the same as each other. In other examples, at least two of the first, second, and third melting points may be different from each other. In some examples, the first, second, and third predetermined time periods may be the same as each other. In other examples, at least two of the first, second, and third predetermined time periods may be different from each other.

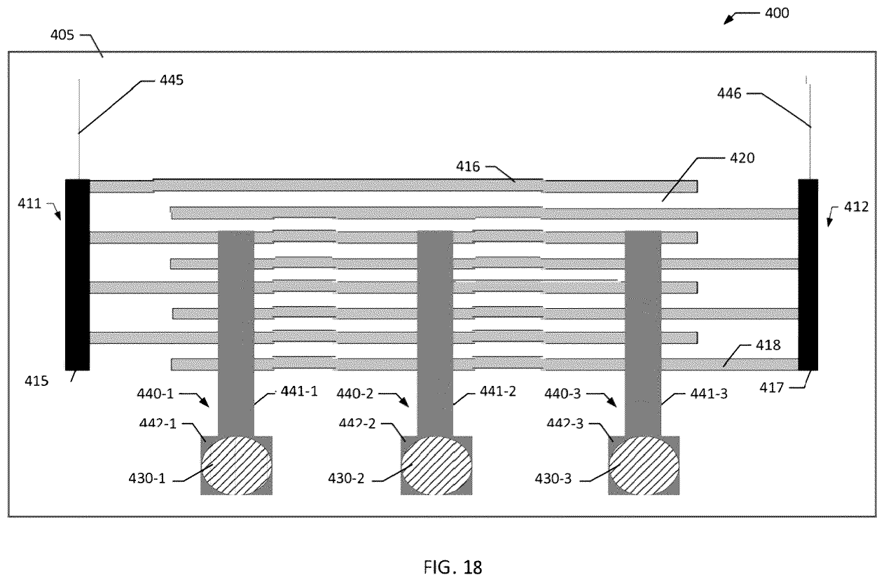

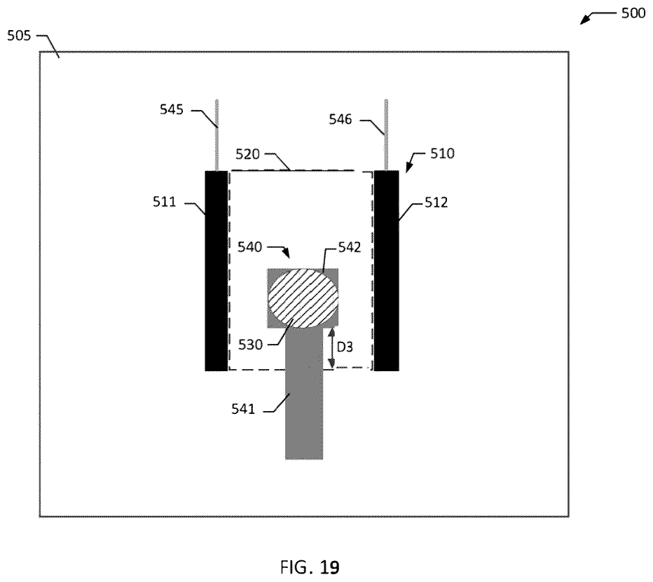

In some examples, as shown in FIG. 17, the paths 440-1, 440-2, 440-3 of the activatable environmental indicator 400 may be disposed below the capacitor 410 (e.g., the sub-electrodes 416, 418). In other examples, as shown in FIG. 18, the paths 440-1, 440-2, 440-3 of the activatable environmental indicator 400 may be disposed above the capacitor 410 (e.g., the sub-electrodes 416, 418).

Other configurations/features/characteristics of the activatable environmental indicator 400 (e.g., indicator material, filer material, melting point, reversibility, color change, response time, material, size of the components, configurations of the multiple indicator materials, cross-sectional views, etc.) may be similar to and/or same as the ones described above with respect to the activatable environmental indicator 100, 200, and/or 300, and, thus, duplicate description may be omitted.

FIG. 19 is a diagram of an activatable environmental indicator 500 according to an example embodiment of the present disclosure. The activatable environmental indicator 500 may include a capacitor 510 having a first electrode 511, a second electrode 512, a gap 520 between the first electrode 511 and the second electrode 512. In some examples, the first electrode 511 may be connected to a first contact terminal 545, and the second electrode 512 may be connected to a second contact terminal 546. In some examples, a substrate 505 may be provided, and the activatable environmental indicator 500 may be disposed on or in the substrate 505.

In some examples, the activatable environmental indicator 500 may further include an encapsulated indicator material 530 and a path 540 for the encapsulated indicator material 530. In some examples, the path 540 may include a reservoir 542 configured to hold the encapsulated indicator material 530 and a channel portion 541 through which the indicator material 530 is configured to move after an activation event that releases the indicator material 530 from the microcapsules 135 and the indicator material 530 is exposed to temperatures above its respective melting point. The path 540 may connect the indicator material 530 to the gap 520.

In some examples, the reservoir 542 may be disposed at one end of the path 540. In other examples, the reservoir 542 may be disposed at any other portion of the path 540 (e.g., in the middle portion of the channel portion 541). As shown in FIG. 19, the reservoir 542 (and the indicator material 530) may be disposed inside the capacitor 510/gap 520.

In some examples, a portion of the channel portion 541 may be disposed between the first electrode 511 and the second electrode 512. In some examples, the length D3 of this portion may be at least 50% of the length of the first/second electrode 511/512, for example, at least 60%, at least 70%, at least 80%, at least 90, or at least 100%. In other examples, the length D3 of this portion of the channel portion 541 may be less than 50% of the length of the first/second electrode 511/512, for example, less than 40%, less than 30%, or less than 20%. In some examples, the length D3 of this portion of the channel portion 541 may be in a range of about 0.5 to 3 inches. In other examples, the length D3 of this portion of the channel portion 541 may have any other suitable value (e.g., 0 to 0.5 inches or greater than 3 inches).

In some examples, the indicator material 530 may migrate/diffuse along the path 540 (e.g., the channel portion 541) and away from the gap 520 after an activation event and in response to exposure to a temperature above a melting point. The migration/diffusion of the indicator material 530 away from the gap 520 may cause a change of the capacitance of the capacitor 510. In some examples, at least a predetermined time period of exposure above the melting point after the activation event is required for the migration of the indicator material 530 to cause the change of the capacitance of the capacitor 510 after an initial exposure to the temperature above the melting point. For example, there may be a change in the capacitance after at least any portion of the indicator material 530 is outside of the gap 520.

Other configurations/features/characteristics of the activatable environmental indicator 500 (e.g., indicator material, filer material, melting point, reversibility, color change, response time, material, size of the components, etc.) may be similar to and/or same as the ones described above with respect to the activatable environmental indicator 100 and, thus, duplicate description may be omitted.

Similar to the activatable environmental indicator 300, in some examples, the activatable environmental indicator 500 may include a plurality of indicator materials (initially disposed inside the gap 520 prior to the exposure to a temperature above the melting point) and paths. In this case, other configurations/features/characteristics of the activatable environmental indicator 500 may be similar to and/or same as the ones described above with respect to the activatable environmental indicator 300 (e.g., other than the structure/location of the indicator materials and paths) and, thus, duplicate description may be omitted.

In some examples, in the activatable environmental indicator 500, the first electrode 511 and the second electrode 512 may be in a comb shape and interleaved with each other, as shown in FIG. 8. In this case, other configurations/features/characteristics of the activatable environmental indicator 500 may be similar to and/or same as the ones described above with respect to the activatable environmental indicator 200 (when there is one indicator material and one path) and/or 400 (when there are multiple indicator materials and multiple paths) and, thus, duplicate description may be omitted.

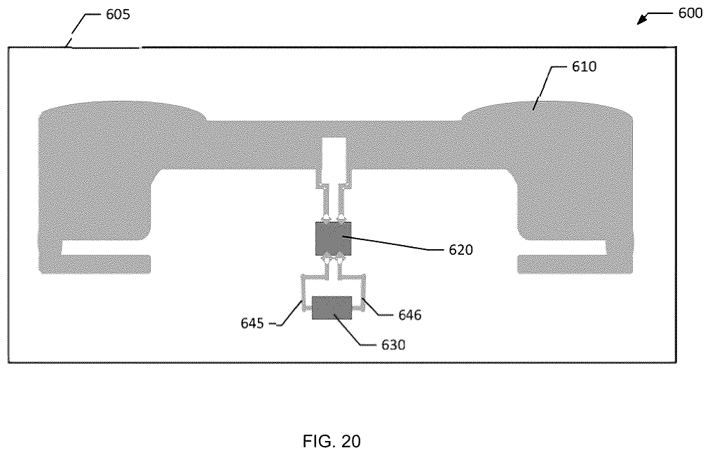

FIG. 20 illustrates an RFID tag system 600 according to an example embodiment of the present disclosure. The RFID tag system 600 may include an antenna 610, an integrated circuit 620 electrically connected to the antenna 610, and an activatable environmental indicator 630 electrically connected to the integrated circuit 620. In some examples, the activatable indicator 630 can be electrically connect to the antenna 610 (e.g., through the integrated circuit 620). The activatable environmental indicator 630 may be one of the activatable environmental indicators described above (e.g., activatable environmental indicator 100, 200, 300, 400, or 500). The RFID tag system 600 may further include a first contact terminal 645 connected to one side of the activatable environmental indicator 630 and a second contact terminal 646 connected to the other side of the activatable environmental indicator 630. The activatable environmental indicator 630 may be connected to the integrated circuit 620 through the first/second contact terminals 645/646. The first/second contact terminals 645/646 may be the first/second contact terminals described above (e.g., first/second contact terminals 145/146, 245/246, 345/346, 445/446, 545/546). The activatable environmental indicator 630 may be connected to dedicated inputs on the integrated circuit 620 to detect, for example, capacitance value/change of the activatable environmental indicator 630. This capacitance value/change of the activatable environmental indicator 630 may be transmitted by the RFID tag to the reader as data bits (along with Tag ID, etc.). In some examples, the integrated circuit may change at least one of a frequency response, a resonant frequency, a phase response, a backscatter signal strength, and an antenna gain in response to temperature exposure dependent changes to capacitance of the activatable environmental indicator 630. In an alternative embodiment, the capacitor itself may be part of the RFID circuit, changing at least one of a frequency response, a resonant frequency, a phase response, a backscatter signal strength, and an antenna gain in response to temperature exposure dependent changes to capacitance of the activatable environmental indicator 630.

In some examples, the activatable environmental indicator 630 may be fully or partially printed on a rigid or flexible substrate 605, for example, by screen printing, thermal-transfer printing, gravure, flexographic, ink jet, or slot die coating. In other examples, the activatable environmental indicator 630 may be printed using any other suitable methods.

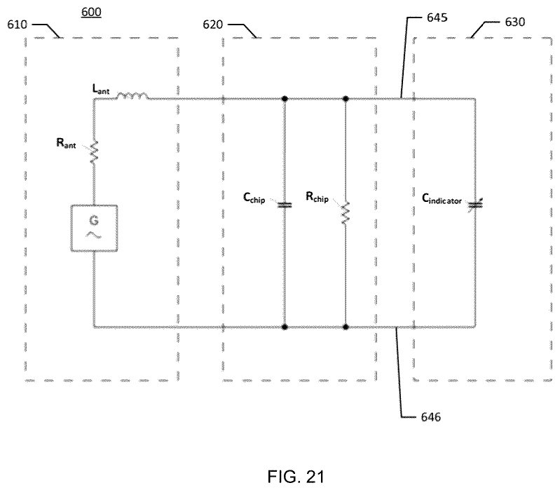

FIG. 21 illustrates a circuit diagram of an example embodiment the RFID tag system 600 according to an example embodiment of the present disclosure. As illustrated in FIG. 21 (and FIG. 20), the activatable environmental indicator 630 may be connected to the integrated circuit 620 and the antenna 610 in parallel. The frequency response of the RFID tag system 600 may be changed based on the melting point and response time of the activatable environmental indicator 630. For example, the melting point and response time of the activatable environmental indicator 630 may be based on the indicator material (e.g., indicator material 130, 230, 330, 430, 530) and design of the activatable environmental indicator 630. In some examples, a change in capacitance of the activatable environmental indicator 630 may alter the impedance of the entire circuit in the RFID system 600, thus, changing the frequency response.

In FIG. 21, G may refer to the sinusoidal voltage generated in the RFID tag antenna 610 from a carrier wave transmitted by an RFID reader. Rₐₙₜ may be the resistance of the antenna 610, Lₐₙₜ may be the inductance of the antenna 610, C_{chip} may be the RFID tag's integrated circuit capacitance, R_{chip} may be the RFID tag's integrated circuit resistance, and C_{indicator} may be the tunable/variable capacitance of the activatable environmental indicator 630 that changes, for example, based on the melting point level (and/or the change in dielectric constant) of the dielectric material of the activatable environmental indicator 630. In some examples, the change to the capacitance/resistance is irreversible.

The change in capacitance can be made as large or as small as needed. In some examples, the specific melting point and/or response time at which the change in resonant frequency is required can be designed, for example, based on selecting the appropriate material and structure for building the activatable environmental indicator 630.

In some examples, the integrated circuit 620 may be configured to detect a capacitance value or the change in capacitance of the activatable environmental indicator 630. In some examples, the RFID tag system 600 may further include a memory configured to record information indicating the detected capacitance value/change of the activatable environmental indicator 630. In some examples, the RFID tag system 600 may further include an RFID reader configured to receive a communication from the integrated circuit 620 or the memory indicating the detected capacitance value/change in capacitance of the activatable environmental indicator 630.

The activatable environmental indicators 100-500 and/or the RFID tag system 600 may be used for a temperature-sensitive product having a host product and a container containing the host product. The activatable environmental indicators 100-500 and/or the RFID tag system 600 may be associated with the host product and/or the container to monitor a temperature change and/or an exposure time of the host product/container. For example, the activatable environmental indicators 100-500 and/or the RFID tag system 600 may be attached to the host product and/or the container or at a place near the host product and/or the container. Examples of host products include food stuffs, flowers, concrete, batteries, vaccines, drugs, medication, pharmaceuticals, cosmeceuticals, nutricosmetics, nutritional supplements, biological materials for industrial or therapeutic uses, medical devices, electrical devices, prophylactics, cosmetics, beauty aids, and perishable munitions and ordnance.

In some examples, the capacitance of the activatable environmental indicators 100-500 may be read using a capacitance meter or a multimeter (e.g., BK 878B). In some examples, the activatable environmental indicators 100-500 may be connected to any suitable RFID chips with dedicated inputs to sense capacitance change. In such cases, the change in temperature and/or the exposure time may be detected as a change in capacitance/resistance by the RFID chip and this information can be stored in a user memory and transmitted to an RFID reader.

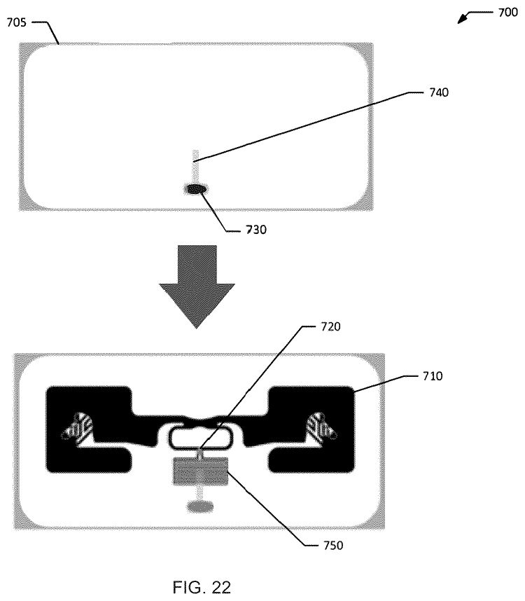

FIG. 22 illustrates an example process 700 of assembling the RFID tag system of FIG. 20. As shown in FIG. 22, a substrate 705 may be provided. On the substrate 705, an indicator material 730 and a path 740 may be provided. Then, an RFID inlay may be placed over the path 740. The RFID inlay may include an antenna 710, an integrated circuit 720, and a capacitor 750 (e.g., capacitors 110, 210, 310, 410, or 510). In this case, the activatable environmental indicator in the RFID system may have a structure shown in FIG. 7, 8A, 8B, 8C, 9, 10A, 10B, or 10C.

In some examples, the RFID inlay may be provided/formed on the substrate 705 first and, then, the path 740 (and the indicator material 730) may be provided on the substrate 705, for example, over the RFID inlay. In this case, the activatable environmental indicator in the RFID system may have a structure shown in FIG. 11, 12A, 12B, 13, 14A, or 14B.

The indicator material 730 may be chosen based on the change in capacitance. In one embodiment, hexanol having a melting point of −44° C. exhibits a change in capacitance of 357,000 pF. In another embodiment, 1-decanol having a melting point of 6° C. exhibits a change in capacitance of 14.3 pF. In another embodiment, glycerol having a melting point of 20° C. exhibits a change in capacitance of 13.7 pF. In another embodiment, 1-dodecanol having a melting point of 24° C. exhibits a change in capacitance of 13.5 pF. In another embodiment, tridecanol having a melting point of 32° C. exhibits a change in capacitance of 9.4 pF. Other indicator materials 730 such as undecanol having a melting point of 11° C. may be utilized.

### Exposure Monitoring Methods

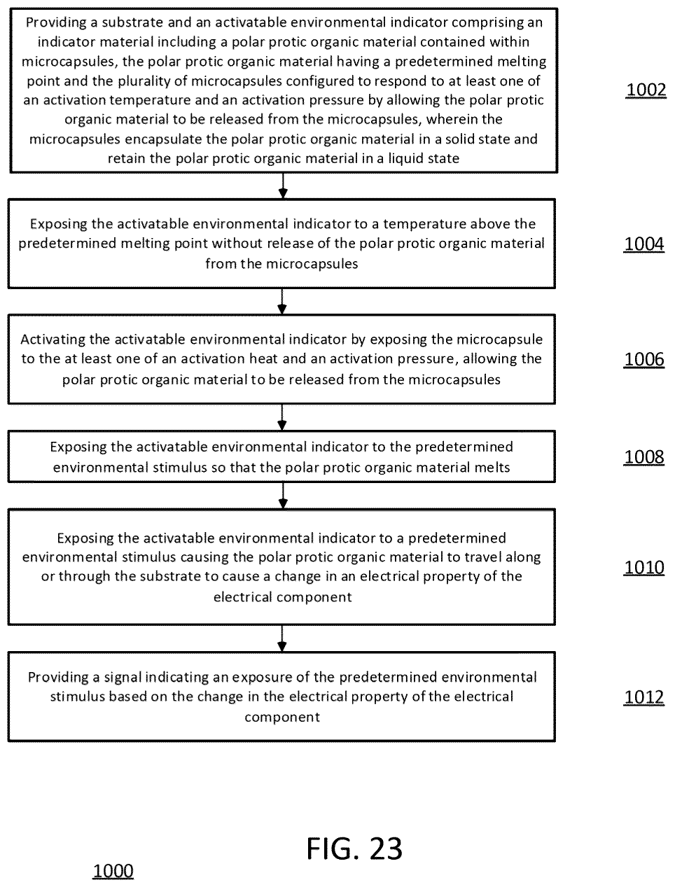

FIG. 23 illustrates a flowchart for an example method 1000 for monitoring exposure to a predetermined environmental stimulus. The method may be carried out using the environmental exposure indicators described in the present disclosure. In 1002, a substrate and an activatable environmental indicator comprise an indicator material including a polar protic organic material contained within a plurality of microcapsules having a predetermined melting point. The plurality of microcapsules is configured to respond to at least one of a heat to reach an activation temperature and an activation pressure. Once exposed to the activation temperature or activation pressure, the polar protic organic material is released from the microcapsules. The microcapsules encapsulate the polar protic organic material in a solid state and retain the polar protic organic material in a liquid state. In 1004, the activatable environmental indicator is exposed to a temperature above the predetermined melting point without release of the polar protic organic material from the microcapsules. In 1006, the activatable environmental indicator is activated by exposing the microcapsule to the at least one of a heat to reach an activation temperature, an activation pressure, or a combination thereof. This allows the polar protic organic material to be released from the microcapsules. The exposure in 1004 may occur concurrent to the activation of the environmental indicator in 1006. In 1008, the activatable environmental indicator is exposed to the predetermined environmental stimulus such that the polar protic organic material melts. In 1010, the activatable environmental indicator is exposed to a predetermined environmental stimulus causing the polar protic organic material to travel along or through the substrate to cause a change in an electrical property of the electrical component. In 1012, a signal is provided indicating an exposure to the predetermined environmental stimulus based on the change in the electrical property of the electrical component. In some embodiments, printing an indicia on the substrate with the direct thermal print or the thermal transfer printer can occur. The printing process may occur prior to the activation event of the environmental indicator, concurrent to the activation event of the environmental indicator, or after the activation event of the environmental indicator as shown in 1004. It will be appreciated that instead of organic polar protic materials, inorganic polar protic materials such as NH₃ may be used.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. Additionally, the described embodiments/examples/implementations should not be interpreted as mutually exclusive, and should instead be understood as potentially combinable if such combinations are permissive in any way. In other words, any feature disclosed in any of the aforementioned embodiments/examples/implementations may be included in any of the other aforementioned embodiments/examples/implementations.

The benefits, advantages, solutions to problems, and any element(s) that may cause any benefit, advantage, or solution to occur or become more pronounced are not to be construed as a critical, required, or essential features or elements of any or all the claims. The claimed invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separately claimed subject matter.

1. An activatable environmental indicator, comprising:
a substrate;
an indicator material further comprising a polar protic organic material, the indicator material having a predetermined melting point; and
a plurality of microcapsules on or embedded in the substrate, the microcapsules encapsulating the indicator material in a solid state, and retaining the indicator material when the indicator material transitions to a liquid state, wherein:
the microcapsules are configured to respond to at least one of an application of heat to reach an activation temperature or an application of an activation pressure, allowing the polar protic organic material to be released from the microcapsules, and
after being released from the microcapsules, the indicator material, responsive to exposure to a temperature above the predetermined melting point, is configured to transition to the liquid state and to travel along or through the substrate to create cause a change in an electrical property of the electrical component, the change in electrical property indicating that the indicator material has been exposed to the temperature above the predetermined melting point.

2. The activatable environmental indicator of claim 1, wherein the indicator material further comprises a polymer having crystallinity.

3. The activatable environmental indicator of claim 1, wherein the polar protic organic material is chosen from a list consisting of polyethylene glycol, acetic acid, methanol, ethanol, propanol, butanol, pentadecanol, hexanol, decanol, undecanol, dodecanol, and tridecanol.

4. The activatable environmental indicator of claim 1, wherein the electrical component is a capacitor and the change of electric property is a change in capacitance of the capacitor.

5. The activatable environmental indicator of claim 1, wherein the electrical component is a capacitance structure including multiple capacitors and the change of electrical property is a change of capacitance of the capacitance structure.

6. The activatable environmental indicator of claim 1, wherein the electrical component is a resistor and the change of electric property is a change in resistance.

7. The activatable environmental indicator of claim 1, wherein the electrical component is part of an RFID tag and the change in electrical property results in a change in information transmitted by the RFID tag, the RFID ceasing to operate, the RFID beginning to operate, or the RFID changing its frequency of transmission.

8. The activatable environmental indicator of claim 1, wherein the electrical component is a capacitor which is part of an RFID tag, and an output of the RFID tag changes based on a change of capacitance of the capacitor caused by the indicator material.

9. The activatable environmental indicator of claim 1, wherein the electrical property of the electrical component changes responsive to contact with the indicator material while the indicator material is in the liquid state.

10. The activatable environmental indicator of claim 1, wherein the electrical property of the electrical component remains altered from the contact with the indicator material after the indicator material returns to the solid state.

11. The activatable environmental indicator of claim 1, wherein the indicator material contacts the electrical component only if it is exposed to a temperature above a melting point of the indicator material for at least a predetermined period of time after the release of the indicator material from the microcapsules.

12. The activatable environmental indicator of claim 1, wherein the activation temperature is above the predetermined melting point, but the temperature is maintained only for sufficiently long to release the indicator material without applying sufficient heat to melt the indicator material.

13. The activatable environmental indicator of claim 12, wherein the microcapsules are further configured to release the indicator material in response to a first activation pressure being applied, and in response to a second activation pressure less than the first activation pressure being applied at or above a predetermined activation temperature.

14. The activatable environmental indicator of claim 1, further comprising a wick on or in the substrate, the wick positioned to allow the indicator material to migrate along the wick towards the electrical component.

15. The activatable environmental indicator of claim 1, wherein the microcapsules are configured to respond to the activation temperature and the activation pressure provided by a direct thermal print head.

16. The activatable environmental indicator of claim 1, wherein the activation temperature is between 90° C. and 110° C.

17. The activatable environmental indicator of claim 1, wherein the activation pressure is between 1.5 to 8 pounds per square inch.

18. The activatable environmental indicator of claim 1, wherein the activation temperature is between 100° C. and 200° C. and the activation pressure is between 4 to 15 pounds per square inch.

19. The activatable environmental indicator of claim 1, wherein the predetermined melting point is between 5° C. and 35° C.

20. The activatable environmental indicator of claim 1, wherein the predetermined melting point is between −40° C. and 100° C.

21. The activatable environmental indicator of claim 1, wherein the microcapsules comprise a gel.

22. The activatable environmental indicator of claim 1, wherein the microcapsules comprise at least one component chosen from the list consisting of a protein, polyurea formaldehyde, polymelamine formaldehyde, a wax material, and an emulsion.

23. The activatable environmental indicator of claim 1, wherein the microcapsules have an outer diameter length between 20 to 250 μm.

24. The activatable environmental indicator of claim 1, wherein the microcapsules respond to at least one of the activation temperature and the activation pressure by fracturing, melting, breaking, dissolving, or becoming porous.

25. The activatable environmental indicator of claim 1, wherein the microcapsules have at least a first wall and a second wall encapsulating the indicator material, wherein the first wall is configured to respond to at least one of the activation temperature and the activation pressure and the second wall is configured to respond to at least one of the activation temperature and the activation pressure, and wherein both walls must respond in order to release the indicator material.

26. An activatable indicator material, comprising:
a polar protic organic material having a predetermined melting point; and
a plurality of microcapsules encapsulating the polar protic organic material in a solid state, and retaining the polar protic organic material when the polar protic organic material transitions to a liquid state while encapsulated, the microcapsules configured to release the polar protic organic material in response to at least one of an activation temperature or an activation pressure.

27-36. (canceled)

37. A method of monitoring exposure to a predetermined environmental stimulus, comprising:
providing a substrate and an activatable environmental indicator comprising an indicator material including a polar protic organic material having a predetermined melting point and a plurality of microcapsules configured to respond to at least one of an activation temperature and an activation pressure by allowing the polar protic organic material to be released from the microcapsules, wherein the microcapsules encapsulate the polar protic organic material in a solid state and retain the polar protic organic material in a liquid state;
activating the polar protic organic material by exposing the microcapsule to the at least one of the activation temperature and the activation pressure, allowing the polar protic organic material to be released from the microcapsules;
exposing the activatable environmental indicator to a predetermined environmental stimulus causing the polar protic organic material to travel along or through the substrate to cause a change in an electrical property of the electrical component, causing a change in an electrical property of the electrical component; and
detecting an exposure of the predetermined environmental stimulus based on the change in the electrical property of the electrical component.

38-67. (canceled)
